(19) United States
(12) Patent Application Publication
(10) Pub. No.: US 2026/0091495 A1
(43) Pub. Date: Apr. 2, 2026

(54) TECHNIQUES FOR ROBOT CONTROL BASED ON DIFFERENTIABLE TASK-AND-MOTION PLANNING

(71) Applicant: NVIDIA CORPORATION, Santa Clara, CA (US)

(72) Inventors: Fabio TOZETO RAMOS, Seattle, WA (US); William SHEN, Cambridge, MA (US); Caelan Reed GARRETT, Seattle, WA (US); Tucker Ryer HERMANS, Salt Lake City, UT (US); Ankit GOYAL, Seattle, WA (US)

(21) Appl. No.: 19/235,090

(22) Filed: Jun. 11, 2025

Related U.S. Application Data
(60) Provisional application No. 63/702,530, filed on Oct. 2, 2024.

(51) Int. Cl. B25J 9/16

(52) U.S. Cl. CPC B25J 9/1664; B25J 9/161; B25J 9/1661

(57) ABSTRACT

Techniques for controlling a robot includes receiving a task and motion planning (TAMP)-domain language input comprising one or more symbolic elements and one or more continuous elements, generating a TAMP-domain representation based on the TAMP-domain language input, TAMP-domain language data, and one or more subgraph classification rules, generating a robot plan based on the TAMP-domain representation, a state, and a goal, and causing the robot to perform at least part of the robot plan.

### CROSS-REFERENCE TO RELATED APPLICATIONS

This application claims priority benefit of the United States Provisional Patent Application titled, “DIFFERENTIABLE GPU-PARALLELIZED TASK AND MOTION PLANNING,” filed on Oct. 2, 2024, and having Ser. No. 63/702,530. The subject matter of this related application is hereby incorporated herein by reference.

### BACKGROUND

### Technical Field

Embodiments of the present disclosure relate generally to computer science, robotics, artificial intelligence, machine learning, and robot control and, more specifically, to techniques for task-and-motion planning.

### Description of the Related Art

Task-and-motion planning (TAMP) enables robots to perform complex, multi-step operations that require both high-level decision-making and low-level geometric reasoning. In a TAMP system, a task planner determines a sequence of discrete actions, such as picking, placing, moving objects, and/or the like, while a motion planner computes feasible continuous robot trajectories for executing the actions without collisions or constraint violations. TAMP is used in a variety of robotic domains, including warehouse automation, manufacturing, logistics, service robotics, and research platforms. In some examples, TAMP systems have to reason over symbolic conditions (e.g., whether a gripper is holding an object) as well as continuous parameters (e.g., robot arm configurations, object poses, grasp poses, and trajectories).

Conventional approaches to TAMP typically separate the task-level reasoning from the motion-level feasibility analysis. In conventional approaches to TAMP, a symbolic task planner generates a discrete sequence of high-level actions (e.g., a plan skeleton) based on logical preconditions and effects defined in a domain-specific language, such as Planning Domain Definition Language (PDDL) and/or the like. Each action in the plan skeleton is then instantiated with continuous parameters, such as robot joint configurations, object poses, grasp transforms, trajectories, and/or the like, which are typically selected or optimized by the TAMP solver. Given the continuous parameter values, a motion planner computes feasible trajectories that satisfy dynamic and kinematic constraints. The motion planner is responsible for generating trajectories, while the TAMP solver handles the broader constraint satisfaction problem that includes sampling or optimizing the other continuous parameters across the full plan. To solve the CSP, conventional approaches to TAMP use a mixture of compositional sampling and numerical optimization approaches. Sampling-based approaches generate candidate parameter values for each constraint independently, using hand-engineered distributions or learned generative models, and then evaluate combinations through rejection sampling. Optimization-based approaches, on the other hand, represent constraints as analytic functions and solve for feasible parameter assignments using first- or second-order gradient methods. Compositional sampling and numerical optimization approaches are often integrated with dedicated solvers for inverse kinematics, collision checking, and trajectory generation, and could include incremental feasibility checks during plan refinement.

One drawback of the above approaches for TAMP is that the above approaches often treat sampling and optimization as isolated processes. Isolation of these processes creates challenges in coordinating constraints that interact across different parts of the plan. For example, sampling-based approaches often sample each parameter independently and rely on rejection to enforce global feasibility, which becomes inefficient when constraints are tightly coupled. For example, in object-packing, tool-use tasks, and/or the like, a valid assignment must often simultaneously satisfy grasp, placement, and collision constraints. Optimization-based approaches, while able to represent constraints jointly in a mathematical program, often suffer from non-convexity and local optima, making optimization-based approaches sensitive to initialization and unlikely to find feasible solutions from random starting points.

Another drawback of the above approaches for TAMP is that, because symbolic plan skeletons are generated independently of the corresponding continuous feasibility constraints, conventional approaches spend significant computation resources exploring skeletons that have no viable parameter assignments. For example, a symbolic planner could generate a plan in which a robot is instructed to grasp an object from a cluttered shelf and place the object inside a container, without accounting for whether a collision-free inverse kinematics (IK) solution exists for the grasp or whether the container location is reachable without interfering with other objects.

As the foregoing illustrates, what is needed in the art are more effective techniques for TAMP.

### SUMMARY

According to some embodiments, a computer-implemented method for controlling a robot includes receiving a task and motion planning (TAMP)-domain language input, a goal, and sensor data. The method also includes generating a plan skeleton based on the TAMP-domain language input, the goal, and the sensor data. In addition, the method includes generating, based on the plan skeleton, one or more feasible particles. The method further includes generating, based on the plan skeleton and at least one of the one or more feasible particles, a robot plan. Furthermore, the method includes causing the robot to perform at least part of the robot plan.

In some embodiments, a computer-implemented method for controlling a robot includes receiving TAMP-domain language input comprising one or more symbolic elements and one or more continuous elements, generating a TAMP-domain representation based on the TAMP-domain language input, TAMP-domain language data, and one or more subgraph classification rules. The method further includes generating a robot plan based on the TAMP-domain representation, a state, and a goal. Furthermore, the method includes causing the robot to perform at least part of the robot plan.

Further embodiments provide, among other things, non-transitory computer-readable storage media storing instructions and systems configured to implement the methods set forth above.

At least one technical advantage of the disclosed techniques relative to the prior art is that the disclosed techniques integrate sampling, optimization, and symbolic planning into a unified TAMP framework, thereby improving coordination between symbolic plan structures and continuous feasibility constraints. Unlike conventional approaches that treat sampling and optimization as isolated processes, the disclosed techniques generate and evaluate candidate plan skeletons using techniques that permit continuous constraints, such as kinematics, collision avoidance, and stability, to be addressed jointly across the robot plan. Furthermore, the disclosed techniques allocate computational resources to plan skeletons that are more likely to yield viable robot plans, avoiding wasted computation on plan skeletons that are infeasible. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computer system configured to implement one or more aspects of the present embodiments;

FIG. 2 is a block diagram of a parallel processing unit included in the parallel processing subsystem of FIG. 1, according to various embodiments;

FIG. 3 is a block diagram of a general processing cluster included in the parallel processing unit of FIG. 2, according to various embodiments;

FIG. 4 is a block diagram of a computer-based system, according to various embodiments;

FIG. 5 is a more detailed illustration of the robot control application of FIG. 4, according to various embodiments;

FIG. 6 is a more detailed illustration of the cuTAMP planner of FIG. 1, according to various embodiments;

FIG. 7 is a more detailed illustration of the TAMP-domain language parser of FIG. 1, according to various embodiments;

FIG. 8 is a flow diagram of method steps for controlling a robot, according to various embodiments;

FIG. 9 is a flow diagram of method steps for generating a robot plan, according to various embodiments; and

FIG. 10 is a flow diagram of method steps for generating a TAMP-domain representation, according to various embodiments.

### DETAILED DESCRIPTION

In the following description, numerous specific details are set forth to provide a more thorough understanding of the various embodiments. However, it will be apparent to one skilled in the art that the concepts can be practiced without one or more of these specific details.

### General Overview

Embodiments of the present disclosure provide techniques for robot control based on differentiable TAMP. In various embodiments, the disclosed techniques include a TAMP-domain language parser. The TAMP-domain language parser processes a TAMP-domain language input and generates a TAMP-domain representation based on TAMP-domain language data and subgraph classification rules. The TAMP-domain language input includes both symbolic elements, such as types, predicates, and actions, and continuous geometric constraints and cost expressions associated with the actions. The TAMP-domain language parser includes a parser and static checker, a constraint-graph builder, a subgraph tagger, and a representation generator. The parser and static checker processes the TAMP-domain language input and TAMP-domain language data and generates an abstract syntax tree, which encodes the hierarchical structure of the domain, which includes actions, parameters, constraints, and cost expressions. The constraint-graph builder processes the abstract syntax tree and generates constraint graph templates, representing reusable parameterized constraint structures associated with each action schema. The subgraph tagger processes the constraint graph templates and the subgraph classification rules and generates subgraph tag metadata, which identifies reusable groups of constraints, such as inverse kinematics, grasp feasibility, or placement stability. The representation generator processes the constraint graph templates and subgraph tag metadata and generates a TAMP-domain representation by serializing the associated metadata into a machine-readable format. The TAMP-domain representation can be processed by any TAMP planner along with state and goal information to generate a robot plan, which causes a robot to perform at least part of a task. In some embodiments, the disclosed techniques include a cuTAMP planner which processes the TAMP-domain representation, state, and goal information and generates a robot plan. In various embodiments, the cuTAMP planner includes a skeleton generator, a particle initializer, a particle optimizer, a feasibility checker, and a plan assembler. The skeleton generator processes the TAMP-domain representation, the state, and the goal and generates a candidate plan skeleton. The particle initializer processes the plan skeleton to generate plan particles. The particle optimizer processes the plan particles and candidate plan skeleton and generates optimized particles. The feasibility checker checks whether one or more optimized particles are feasible based on the plan skeleton and ranks optimized plan particles based on heuristics. Whenever one or more feasible particles are found, the plan assembler assembles the candidate plan skeleton and the feasible particle with the highest rank into a robot plan. Whenever a feasible particle is not found, cuTAMP planner prompts the skeleton generator to generate another candidate plan skeleton and the process repeats until a feasible particle is found. The robot plan can be used by a robot control application to cause a robot to perform at least part of a task.

The robot control techniques of the present disclosure have many real-world applications. For example, the robot control techniques could be used to control a physical robot in a real-world environment or a simulated robot in a virtual environment. As another example, the robot control techniques could be used to control other characters having movable joints like a robot. The robot control techniques can also be applied in other application including autonomous vehicles, non-player characters (NPCs) in video games, simulated agents in training environments, or any application that includes planning and executing physically feasible motion subject to discrete and continuous constraints.

The above examples are not in any way intended to be limiting. As persons skilled in the art will appreciate, as a general matter, the robot control techniques described herein can be implemented in any suitable application.

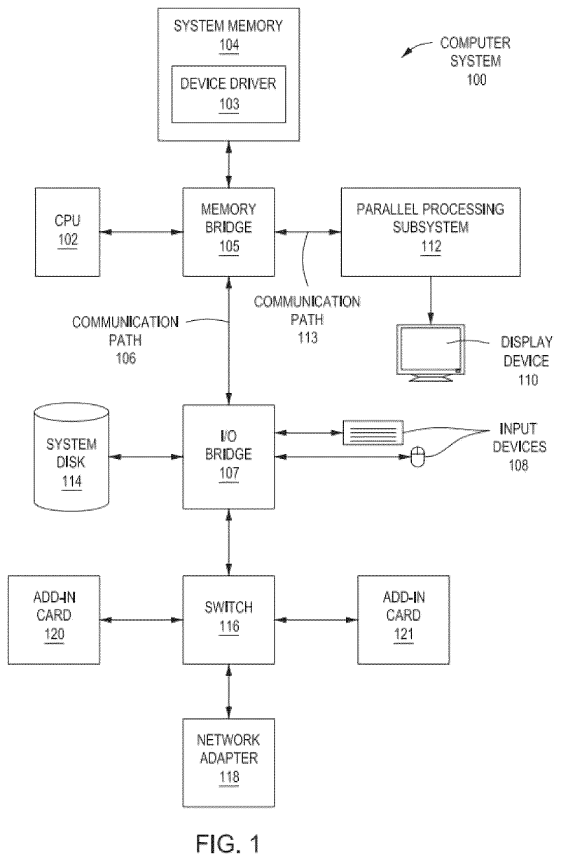

FIG. 1 is a block diagram of a computer system 100 configured to implement one or more aspects of the present disclosure. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116. As persons skilled in the art will appreciate, computer system 100 can be any type of technically feasible computer system, including, without limitation, a server machine, a server platform, a desktop machine, laptop machine, or a hand-held/mobile device. Persons skilled in the art also will appreciate that computer system 100 or systems similar to computer system 100 can be incorporated into a vehicle or machine to facilitate driving, steering, or otherwise controlling that vehicle or machine, as the case may be.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbrige chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

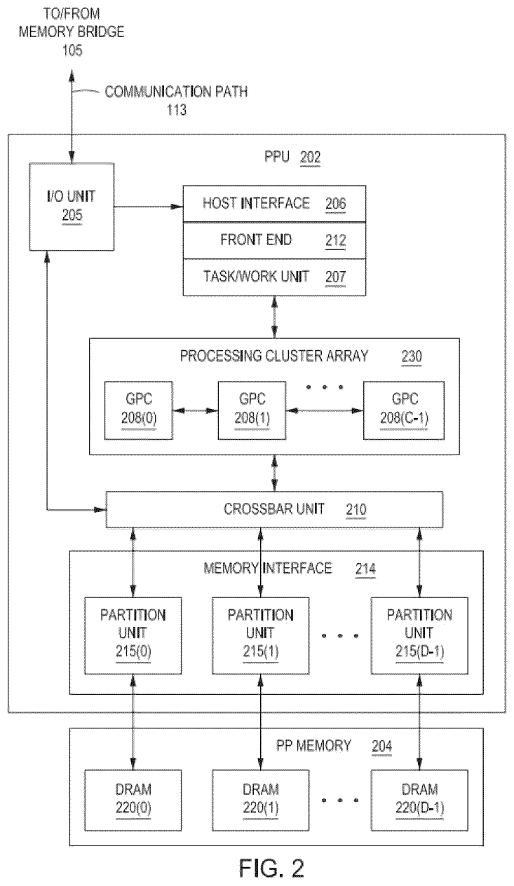

In some embodiments, parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in FIG. 2, such circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 may be integrated with one or more other the other elements of FIG. 1 to form a single system. For example, parallel processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the parallel processing subsystem 112 of FIG. 1, according to various embodiments of the present disclosure. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computer system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computer system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C≥1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D□1. Each partition unit 215 is coupled to one or more dynamic random access memories (DRAMs) 220 residing within PPM memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPCs 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

As noted above, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

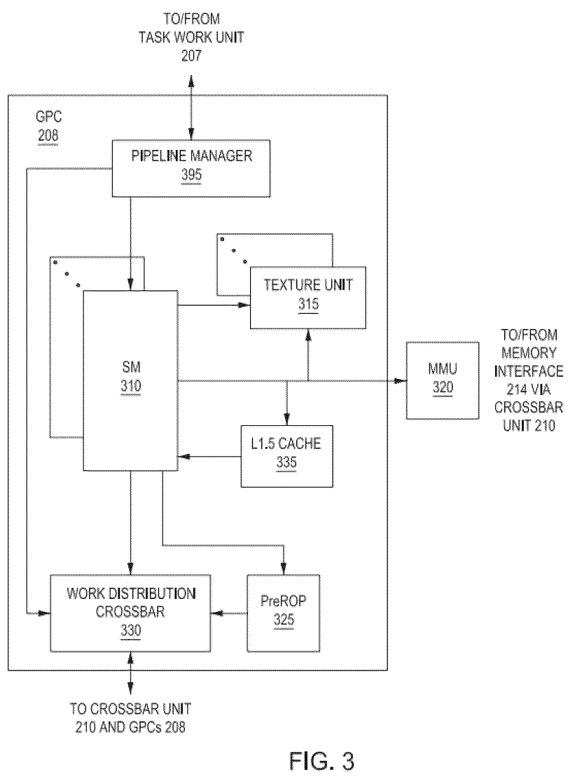

FIG. 3 is a block diagram of a GPC 208 included in PPU 202 of FIG. 2, according to various embodiments of the present disclosure. In operation, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

Operation of GPC 208 is controlled via a pipeline manager 395 that distributes processing tasks received from a work distribution unit (not shown) within task/work unit 207 to one or more streaming multiprocessors (SMs) 310. Pipeline manager 395 may also be configured to control a work distribution crossbar 330 by specifying destinations for processed data output by SMs 310.

In one embodiment, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, XOR), bit-shifting, and computation of various algebraic functions (e.g., planar interpolation and trigonometric, exponential, and logarithmic functions, etc.). Advantageously, the same functional execution unit can be configured to perform different operations.

In operation, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within the SM 310, in which case some of the execution may be idle during cycles when that thread group is being processed. A thread group may also include more threads than the number of execution units within the SM 310, in which case processing may occur over consecutive clock cycles. Since each SM 310 can support up to G thread groups concurrently, it follows that up to G*M thread groups can be executing in GPC 208 at any given time.

Additionally, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 310, and m is the number of thread groups simultaneously active within the SM 310.

Although not shown in FIG. 3, each SM 310 contains a level one (L1) cache or uses space in a corresponding L1 cache outside of the SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, the SMs 310 may beneficially share common instructions and data cached in L1.5 cache 335.

Each GPC 208 may have an associated memory management unit (MMU) 320 that is configured to map virtual addresses into physical addresses. In various embodiments, MMU 320 may reside either within GPC 208 or within the memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In graphics and compute applications, GPC 208 may be configured such that each SM 310 is coupled to a texture unit 315 for performing texture mapping operations, such as determining texture sample positions, reading texture data, and filtering texture data.

In operation, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the core architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs. In view of the foregoing, persons of ordinary skill in the art will appreciate that the architecture described in FIGS. 1-3 in no way limits the scope of the present disclosure.

### Robot Control Based on Differentiable Tamp

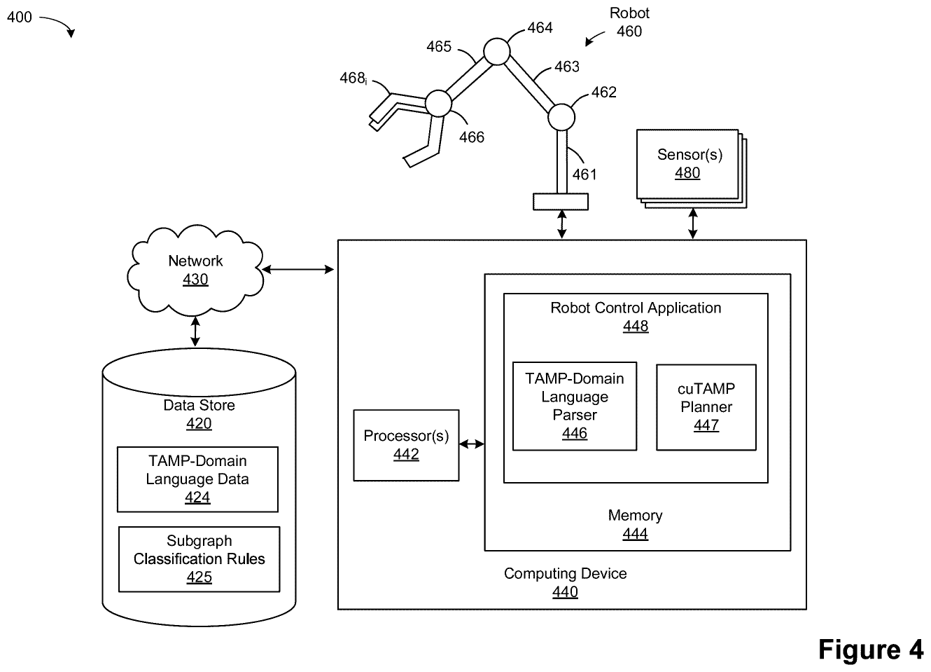

FIG. 4 is a block diagram of a computer-based system, according to various embodiments. As shown, system 400 includes, without limitation, a computing device 440, a data store 420, a network 430, a robot 460, and one or more sensors 480. Computing device 440 includes, without limitation, one or more processors 442 and a memory 444. Memory 444 includes, without limitation, a robot control application 448. Robot control application 448 includes, without limitation, a TAMP-domain language parser 446 and a cuTAMP planner 447. Data store 420 includes, without limitation, TAMP-domain language data 424 and one or more subgraph classification rules 425. Robot 460 includes multiple links 461, 463, and 465 that are rigid members, as well as joints 462, 464, and 466, which are movable components that can be actuated to cause relative motion between adjacent links. In addition, robot 460 includes multiple fingers 468i (referred to herein collectively as fingers 468 and individually as a finger 468) that can be controlled to grip an object (not shown). Although FIG. 4 is described in the context of a robotic planning and control system, it is understood that the disclosed techniques are applicable to a wide range of domains including but not limited to task-and-motion planning, assembly line design, smart power grid management, programming video game non-playable characters, high-dimensional constraint satisfaction, and optimization.

Computing device 440 shown herein is for illustrative purposes only, and variations and modifications in the design and arrangement of computing device 440, without departing from the scope of the present disclosure. For example, the number of processor(s) 442, the number of and/or type of memories 444, and/or the number of applications and or data stored in memory 444 can be modified as desired. In some embodiments, any combination of processor(s) 442 and/or memory 444 can be included in and/or replaced with any type of virtual computing system, distributed computing system, and/or cloud computing environment, such as a public, private, or a hybrid cloud system.

Each of processor(s) 442 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processor(s) 442 can be any technically feasible hardware unit capable of processing data and/or executing software applications.

Memory 444 of computing device 440 stores content, such as software applications and data, for use by processor(s) 442. As shown, memory 444 includes, without limitation, a robot control application 448. Memory 444 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 444. The storage can include any number and type of external memories that are accessible to processor(s) 442. For example, and without limitation, the storage can include a Secure Digital Card, an external Flash memory, a portable CD-ROM, an optical storage device, a magnetic storage device, and/or any suitable combination of the foregoing.

Data store 420 can include any storage device or devices, such as fixed disc drive(s), flash drive(s), optical storage, network attached storage (NAS), and/or a storage area-network (SAN). Although shown as accessible over network 430, in some embodiments computing device 440 can include data store 420. As shown, data store 420 stores, without limitation, TAMP-domain language data 424 and subgraph classification rules 425.

TAMP-domain language data 424, which can be stored in data store 420 or elsewhere (e.g., in memory 444), includes, without limitation, definitions of symbolic elements, such as types (e.g., object, surface, robot), predicates (e.g., At, Holding, HandEmpty), and action schemas (e.g., Pick, Place, Move), as well as continuous elements, such as configuration types (e.g., conf), grasp types, placement types, and trajectory types. TAMP-domain language data 424 also includes constraint function definitions (e.g., Kin for kinematics feasibility, CFreeTraj for collision-free trajectory feasibility, StablePlace for stable object placement) and cost function definitions (e.g., TrajLength for minimizing trajectory length), along with associated metadata, such as function arity, expected argument types, differentiability flags, and default tolerance values.

Subgraph classification rules 425, which can be stored in data store 420 or elsewhere (e.g., in memory 444), include, without limitation, information that defines how individual constraints in the TAMP-domain language input can be grouped into constraint subgraphs. In some embodiments, subgraph classification rules 425 are used by TAMP-domain language parser 446 to process constraint graph templates and generate a subgraph tag metadata, in which each constraint is annotated with a subgraph label (e.g., tag) indicating shared structure, variable overlap, and/or the like. For example, subgraph classification rules 425 can specify that certain constraint functions, such as forward kinematics (Kin), grasp feasibility (Grasp), or collision-free trajectory feasibility (CFreeTraj), are assigned to the same subgraph category (e.g., “IK”, “GraspFeasibility”, “Trajectory”) when the certain constraint functions include overlapping continuous variables, such as robot configurations, object poses, or grasp parameters. In some embodiments, subgraph classification rules 425 include one or more mappings from constraint function identifiers to subgraph tags or logical groupings. Subgraph classification rules 425 can be defined manually or generated programmatically based on one or more variable dependency patterns.

Network 430 can be a wide area network (WAN), such as the Internet, a local area network (LAN), a cellular network, and/or any other suitable network. Computing devices 440 and data store 420 are in communication over network 430. For example, network 430 can include any technically feasible network hardware suitable for allowing two or more computing devices to communicate with each other and/or to access distributed or remote data storage devices, such as data store 420.

Robot control application 448 is an application that processes a TAMP-domain language input and a goal received as well as sensor data received from one or more sensors 480ᵢ (referred to herein collectively as sensors 480 and individually as a sensor 480) and generates a robot plan, based on TAMP-domain language data 424 and subgraph classification rules 425. Robot control application 448 includes, without limitation, TAMP-domain language parser 446 and cuTAMP planner 447. The TAMP-domain language input defines a planning domain that includes both symbolic and continuous elements, such as object types (e.g., object, surface), robot configuration types (e.g., conf for robot joint states), grasp types, placement types, symbolic predicates (e.g., At, Holding, HandEmpty), real-valued constraint functions (e.g., Kin, CFreeTraj, StablePlace), cost expressions (e.g., TrajLength), and/or the like. The goal includes a desired symbolic condition that robot 460 is planned to achieve, such as Holding(robot, object), Placed(object, target_location), and/or the like, and can be specified either in general form (e.g., any object should be placed on any surface, or the robot should be holding some item) or using specific objects and positions (e.g., Holding(robot1, red_block), Placed(red_block, bin1), or At(green_cube, table3)).

Sensor data received from sensors 480 includes any information that characterizes the state of the environment and robot 460 and can be used to determine which symbolic conditions are true and to assign specific values to physical parameters. Examples of sensor data include, without limitation, red-green-blue (RGB) images or depth maps from cameras (e.g., used for object detection or pose estimation), 3D point clouds from Light Detection and Ranging (LiDAR), structured light sensors (e.g., used for obstacle mapping or surface modeling), joint encoder values (e.g., used to determine the current configuration of robot 460), force-torque measurements (e.g., used for grasp stability assessment), gripper state (e.g., open or closed), and/or the like. In some embodiments, sensor data can be processed by a perception module (not shown) included in robot control application 448 to extract information about the current state of the environment and robot 460, such as the estimated pose of an object, whether a surface is available for placing an item, and/or the like. The state information is then used to determine which symbolic conditions apply and to compute specific values for variables used in TAMP. For example, the perception module can process a camera feed to determine that a red cube is located at position (x, y, z) on the table, which can then be translated into symbolic predicates (e.g., At(red_cube, table)) and associated continuous parameters (e.g., placement_pose_red_cube) in terms of TAMP-domain language input 501. The sensor data can be received periodically or continuously and can be fused from sensors 480. The robot plan includes both a discrete sequence of high-level actions (e.g., Pick, MoveFree, Place) and a corresponding set of continuous parameters (e.g., joint configurations, grasp poses, trajectories) that satisfy the geometric constraints that are permitted to safely and feasibly execute at least part of a task by robot 460. In some embodiments, robot control application 448 uses any suitable control and motion planning techniques to process the robot plan and generate one or more control signals for robot 460. For example, robot control application 448 can use inverse kinematics solvers, trajectory interpolation, model predictive control (MPC), feedback-based motion controllers, and/or the like, to compute actuator commands that cause robot 460 to execute the robot plan. Robot control application 448 is described in greater detail in conjunction with FIG. 4.

Although TAMP-domain language parser 446 and cuTAMP planner 447 are illustrated as components of robot control application 448 within computing device 440, in some embodiments one or both of the components could be deployed on separate computing devices. For example, the TAMP-domain language parser 446 can reside on a remote development or language parsing server, while cuTAMP planner 447 executes on an embedded system onboard the robot or on a dedicated GPU-enabled edge device, such as computing device 440. In such configurations, the components can communicate via a network, such as network 430, connection or shared data interface to exchange the TAMP-domain representation.

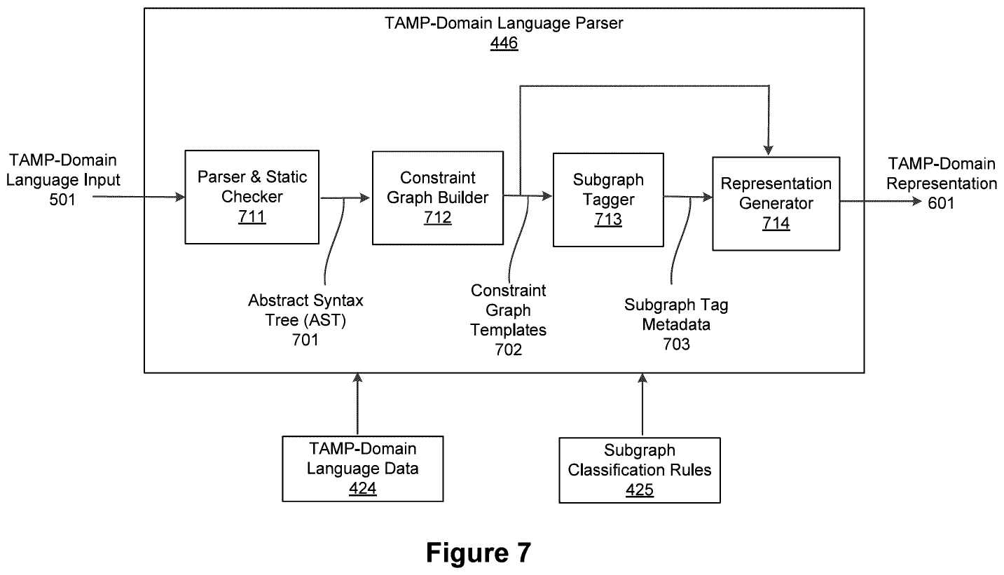

TAMP-domain language parser 446 is an application that processes the TAMP-domain language input and generates a TAMP-domain representation using TAMP-domain language data 424 and subgraph classification rules 425. The TAMP-domain representation includes, without limitation, the definitions of object and robot types, symbolic actions and predicates, continuous variables (e.g., grasps, placements, trajectories), geometric constraints (e.g., inverse kinematics, collision avoidance), and cost terms. In some embodiments, TAMP-domain language parser 446 includes, without limitation, a parser and static checker, a constraint-graph builder, a subgraph tagger, and a representation generator. The parser and static checker processes the TAMP-domain language input and TAMP-domain language data 424 to generate an abstract syntax tree (AST) that encodes the hierarchical structure of the domain, including actions, parameters, constraints, and cost expressions. The constraint-graph builder processes the AST to generate constraint graph templates, in which nodes represent symbolic or continuous variables and constraints, and edges indicate parameter dependencies. The subgraph tagger applies subgraph classification rules 425 to group related constraints, such as inverse kinematics, grasp feasibility, and placement stability, into subgraph tag metadata that enables modular sampling and reuse. The representation generator then serializes the constraint templates, the subgraph tag metadata, and associated metadata into a machine-readable TAMP-domain representation (e.g., in JavaScript Object Notation (JSON) format), which can be consumed by any compatible TAMP planner, such as cuTAMP planner 447. For example, a TAMP-domain language input could define an action Pick(r, o, g) with symbolic preconditions, such as HandEmpty(r), and continuous constraints, such as Kin(r, o, g), which TAMP-domain language parser 446 processes. TAMP-domain language parser 446 is described in greater detail in conjunction with FIG. 7.

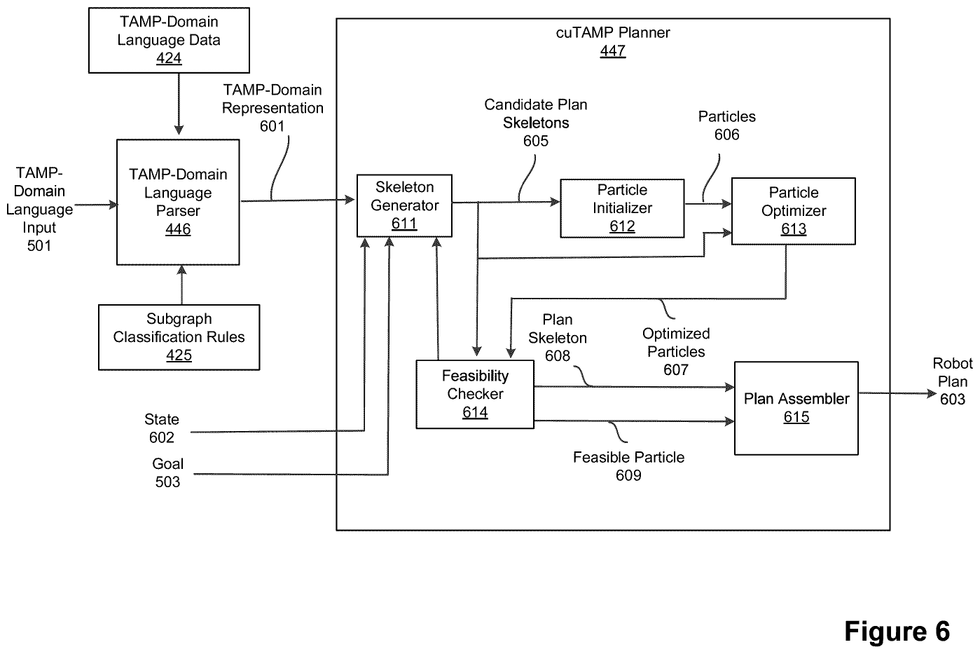

cuTAMP planner 447 is an application that process TAMP-domain representation and the goal state, along with the current state of robot 460 and the surrounding environment (e.g., detected object positions, robot configuration), and generates a robot plan. In some embodiments, cuTAMP planner 447 includes, without limitation, a skeleton generator, a particle initializer, a particle optimizer, a feasibility checker, and a plan assembler. The skeleton generator processes the TAMP-domain representation along with the current state and goal to generate a candidate plan skeleton, which is a sequence of discrete actions (e.g., [Pick→Move→Place]) without specific continuous parameters. The particle initializer then processes the plan skeleton and uses constraint subgraph decomposition to generate a batch of sampled parameter assignments, referred to as plan particles. The particle optimizer refines the particles using gradient-based optimization techniques (e.g., adaptive moment estimation (Adam)) to improve constraint satisfaction. The feasibility checker evaluates the optimized particles to determine whether one or more satisfy all required geometric and symbolic constraints, and ranks the particles based on heuristics, such as constraint satisfaction scores. If at least one feasible particle is found, the plan assembler combines the plan skeleton with the highest-ranked feasible particle to generate a robot plan that includes both symbolic actions and corresponding continuous parameters (e.g., grasp poses, arm configurations, trajectories). If no feasible particle is found, the cuTAMP planner prompts the skeleton generator to generate a new plan skeleton, and the process repeats until a feasible plan is identified. In some embodiments, one or more components of cuTAMP planner 447, such as the particle initializer, particle optimizer, and/or feasibility checker, are configured to execute in parallel or on a GPU to accelerate sampling and optimization. For example, given a task to place a block into a bin, cuTAMP planner 447 can generate and optimize thousands of parameter samples simultaneously using GPU parallelism, ultimately generating a robot plan, where robot 460 safely picks the block from a cluttered tabletop and places the block into the bin using a collision-free, dynamically feasible robot plan. cuTAMP planner 447 is described in greater detail in conjunction with FIG. 6.

As shown, robot 460 includes multiple links 461, 463, and 465 that are rigid members, as well as joints 462, 464, and 466, which are movable components that can be actuated to cause relative motion between adjacent links. In addition, robot 460 includes multiple fingers 468 that can be controlled to grip an object. For example, in some embodiments, robot 460 can include a locked wrist and multiple fingers. Although an example robot 460 is shown for illustrative purposes, in some embodiments, techniques disclosed herein can be applied to control any suitable robot.

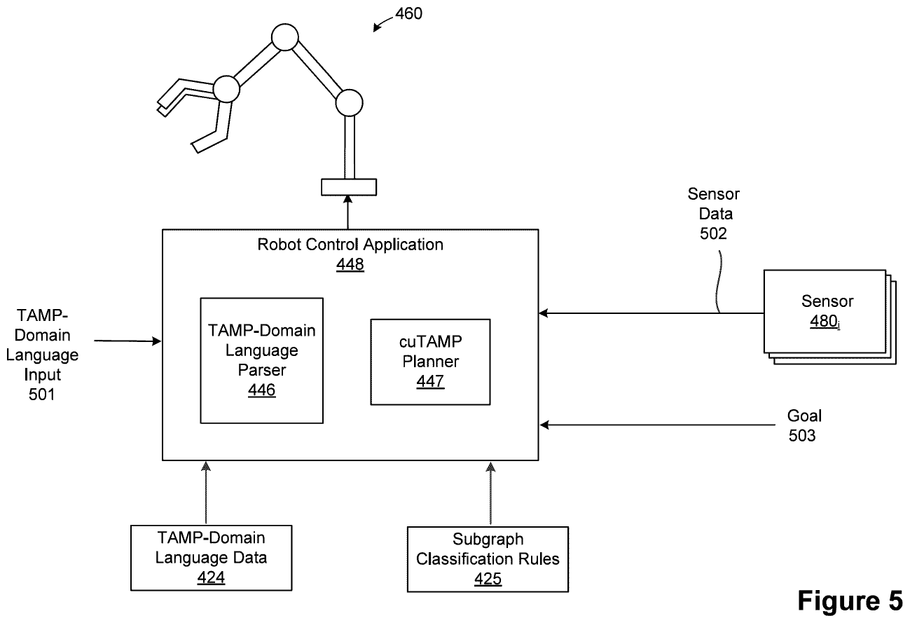

FIG. 5 is a more detailed illustration of robot control application 448, according to various embodiments. As shown, robot control application 448 includes, without limitation, TAMP-domain language parser 446 and cuTAMP planner 447. In operation, robot control application 448 receives TAMP-domain language input 501 and goal 503 via one or more I/O devices as well as sensor data 502 from sensors 480. Robot control application 448 uses TAMP-domain language parser 446 to process TAMP-domain language input 501, based on TAMP-domain language data 424 and subgraph classification rules 425, and cuTAMP planner 447 to process sensor data 502 and goal 503 and generate a robot plan causing robot 460 to perform at least part of a task.

Robot control application 448 processes TAMP-domain language input 501, sensor data 502, and goal 503 and generates a robot plan, based on TAMP-domain language data 424 and subgraph classification rules 425. In some embodiments, sensor data 502 can be processed by a perception module (not shown) included in robot control application 448 to extract information about the current state of the environment and robot 460, such as the estimated pose of an object, whether a surface is available for placing an item, and/or the like. The perception module then uses the information to determine which symbolic conditions apply and to compute specific values for variables used in TAMP. For example, the perception module can process a camera feed to determine that a red cube is located at position (x, y, z) on the table, which can then be translated into symbolic predicates (e.g., At(red_cube, table)) and associated continuous parameters (e.g., placement_pose_red_cube) in terms of TAMP-domain language input 501. The sensor data can be received periodically or continuously and can be fused from sensors 480. In some embodiments, robot control application 448 uses any suitable control and motion planning techniques to process the robot plan and generate one or more control signals for robot 460. For example, robot control application 448 can use inverse kinematics solvers, trajectory interpolation, MPC, feedback-based motion controllers, and/or the like, to compute motor commands that cause robot 460 to execute the robot plan. Robot control application 448 is described in greater detail in conjunction with FIG. 5.

TAMP-domain language parser 446 processes the TAMP-domain language input 501 and generates a TAMP-domain representation using TAMP-domain language data 424 and subgraph classification rules 425. In some embodiments, TAMP-domain language parser 446 includes, without limitation, a parser and static checker, a constraint-graph builder, a subgraph tagger, and a representation generator. The parser and static checker processes the TAMP-domain language input 501 and TAMP-domain language data 424 to generate an AST that encodes the hierarchical structure of the domain. The constraint-graph builder processes the AST to generate a constraint graph. The subgraph tagger applies subgraph classification rules 425 to group related constraints into a tagged graph. The representation generator then serializes the tagged graph and associated metadata into a machine-readable TAMP-domain representation, which can be consumed by any compatible TAMP planner, such as cuTAMP planner 447.

cuTAMP planner 447 processes TAMP-domain representation and the goal 503, along with the current state of robot 460 and the surrounding environment, and generates a robot plan. In some embodiments, cuTAMP planner 447 includes, without limitation, a skeleton generator, a particle initializer, a particle optimizer, a feasibility checker, and a plan assembler. The skeleton generator processes the TAMP-domain representation along with the current state and goal to generate a candidate plan skeleton, which is a sequence of discrete actions without specific continuous parameters. The particle initializer then processes the candidate plan skeleton and uses constraint subgraph decomposition to generate a batch of sampled parameter assignments, referred to as plan particles. The particle optimizer refines the particles using gradient-based optimization techniques to improve constraint satisfaction. The feasibility checker evaluates the optimized particles to determine whether one or more satisfy all required geometric and symbolic constraints, and ranks the particles based on heuristics, such as constraint satisfaction scores. If at least one feasible particle is found, the plan assembler combines the plan skeleton with the highest-ranked feasible particle to generate a robot plan that includes both symbolic actions and corresponding continuous parameters. If no feasible particle is found, the feasibility checker prompts the skeleton generator to generate a new plan skeleton, and the process repeats until a feasible plan is identified. In some embodiments, one or more components of cuTAMP planner 447, such as the particle initializer, particle optimizer, and feasibility checker, are configured to execute in parallel or on a GPU to accelerate sampling and optimization.

FIG. 6 is a more detailed illustration of cuTAMP planner 447, according to various embodiments. As shown, cuTAMP planner 447 includes, without limitation, a skeleton generator 611, a particle initializer 612, a particle optimizer 613, a feasibility checker 614, and a plan assembler 615. In operation, TAMP-domain language parser 446 processes TAMP-domain language input 501 and generates TAMP-domain representation 601, based on TAMP-domain language data 424 and subgraph classification rules 425. Skeleton generator 611 process TAMP-domain representation 61 and generates candidate plan skeletons 605. Particle initializer 612 processes candidate plan skeletons 605 and generates particles 606. Particle optimizer 613 processes particles 606 and candidate plan skeletons 605 and generates optimized particles 607. Feasibility checker 614 processes candidate plan skeletons 605 and optimized particles 607 and check the feasibility of optimized particles 607. Whenever feasibility checker 614 determines the existence of at least one feasible particle 609, feasibility checker 614 generates plan skeleton 608 and feasible particle 609. Whenever feasibility checker 614 does not determine the existence of at least one feasible particle 609, feasibility checker 614 prompts skeleton generator 611 to generate another candidate plan skeleton 605. Plan assembler assembles plan skeleton 608 and feasible particle 609 into robot plan 603.

TAMP-domain language parser 446 processes the TAMP-domain language input 501 and generates a TAMP-domain representation 601 using TAMP-domain language data 424 and subgraph classification rules 425. In some embodiments, TAMP-domain language parser 446 includes, without limitation, a parser and static checker, a constraint-graph builder, a subgraph tagger, and a representation generator. The parser and static checker processes the TAMP-domain language input 501 and TAMP-domain language data 424 to generate an AST that encodes the hierarchical structure of the domain. The constraint-graph builder processes the AST to generate a constraint graph. The subgraph tagger applies subgraph classification rules 425 to group related constraints into a tagged graph. The representation generator then serializes the tagged graph and associated metadata into a machine-readable TAMP-domain representation 601, which can be consumed by any compatible TAMP planner, such as cuTAMP planner 447. TAMP domain language parser 446 is described in further detail below in conjunction with FIG. 7.

In some embodiments, a TAMP problem can be defined as a tuple Π=<A, s₀,S_{*}>, where A is a set of parametrized actions, s₀ is the initial state 602, and S, is the set of goal 503 states. State and actions are defined in terms of TAMP-domain language input 501, where states are comprised of Boolean variables corresponding to logical propositions. For example, the predicate AtPlacement (o, p) holds whenever object o is currently located at placement pose p. Each parameterized action a∈A accepts a set of parameters xₐ=(x₁, . . . , xₙ), which may include both discrete and continuous values. An action includes a set of constraints con (a) on the parameters, all of which must be satisfied for the action to be valid in a given state. Each constraint c∈con (a) is assumed to be expressed as an equality or inequality over a differentiable real-valued function, denoted J_{c}. In addition to constraints, each action specifies a set of preconditions pre (a), which must all hold true for the action to be applicable in a given state, and a set of effects eff(a), which describe how the symbolic state changes after the action is executed. In some embodiments, actions can be associated with a cost function cost(a) over the parameters. For example, consider the following example TAMP-domain language input 501:

$$Pick ( o \text{:} obj , g \text{:} grasp , p \text{:} placement , q \text{:} conf ) : \qquad ( Equation 1 )$$

$$con \text{:} Kin ( q , o , g , p ) Grasp ( o , g ) , CFreeHold ( o , g , q )$$

$$pre : HandEmpty ( ) , AtConf ( q ) , AtPlacement ( o , p )$$

$$eff : Holding ( o , g ) , ¬ HandEmpty ( ) , ¬ AtPlacement ( o , p )$$

In Equation 1, the Pick action describes grasping object o, with the grasp g, when at pose p, and corresponding robot configuration q. The preconditions are (1) HandEmpty( ) (e.g., the gripper of robot 460 must be empty), (2) AtConf (q) (e.g., robot 460 must be at configuration q, and (3) AtPlacement (o,p) (e.g., object o must be at placement pose p). As a result of executing the Pick action, Grasp (o,g) (e.g., robot 460 holds object o with grasp g) is now true but HandEmpty ( ) and AtPlacement (o, p) are now false. To execute the action, the kinematic constraint Kin(q, o, g, p) has to be satisfied (e.g., FK(q)=p·g, where FK is forward kinematics), g is a valid grasp for object o as required by Grasp(o, g), and the grasp is Collision-Free (CFree) at configuration q required by CFreeHold (o, g, q). In some embodiments, the objective of cuTAMP planner 447 is to find plan skeleton 608 included in robot plan 603 π=(a₁, . . . , aₙ) with valid parameter assignments (e.g., a particle) {xₐ|a∈π}, such that when applied from the initial state 602 s₀, the robot plan 603 renders robot 460 to goal 503 state s∈S, while minimizing an overall given cost. For example, consider the following example candidate plan skeleton 605 included in robot plan 603 for placing object red on surface table, where constant continuous parameters are bolded:

$$π = [ MoveFree ( {q}_{0} , {q}_{1} , {τ}_{1} ) , Pick ( red , g , {p}_{0} , {q}_{1} ) , MoveHold ( red , g , {q}_{1} , {q}_{2} , {τ}_{2} ) , Place ( red , g , {p}_{1} , table , {q}_{2} ) . \qquad ( Equation 2 )$$

In some embodiments, parameters in robot plan 603 can be shared across actions. For example, in order to Pick object red at configuration q₁, robot 460 has to first use MoveFree to move from the initial configuration q₀ to q₁. In various embodiments, a challenge in TAMP is that continuous constraints can restrict the set of viable candidate plan skeletons 605. For example, a blue object can initially obstruct the red object, causing CFreeHold in Pick to be false in Equation 1. Candidate plan skeleton 605 would admit no solutions as long as blue is at the initial placement. In some embodiments, the objective is to reach a state that additionally minimizes a cost function, such as the goal distance between objects. For example, costs on the goal 503 state can be treated as a dummy action with costs that are appended as the final action in candidate plan skeletons 605. For example, given the candidate plan skeleton 605 described in Equation 2, the action for three objects is defined as follows: let o₁, o₂, o₃ be objects, and p₁, p₂, p₃ be the respective placements. In some examples, cuTAMP planner 447 solves the following optimization objective

$$MinimizeObjDist ( {o}_{1} , {o}_{2} , {o}_{3} : obj ; {p}_{1} , {p}_{2} , {p}_{3} : placement ) \begin{matrix}subject to : AtPlacement ( {o}_{1 ,} {p}_{1} ) , \\ AtPlacement ( {o}_{2 ,} {p}_{2} ) , \\ AtPlacement ( {o}_{3 ,} {p}_{3} ) , \\ cost : Dist ( {p}_{1 ,} {p}_{2} ) + Dist ( {p}_{2 ,} {p}_{3} ) + Dist ( {p}_{1 ,} {p}_{3} ) .\end{matrix} \qquad ( Equation 3 )$$

Skeleton generator 611 processes TAMP-domain representation 601, state 602, and goal 503 and generates candidate plan skeletons 605. Each candidate plan skeleton 605 is a symbolic representation of a candidate robot plan that specifies a sequence of high-level actions along with the associated symbolic structure, but without assigning specific continuous values (e.g., poses, trajectories, or joint configurations). Each action in candidate plan skeleton 605 includes symbolic parameters (e.g., for a robot, object, grasp, or placement), as well as references to the preconditions, constraints, and plan cost expressions defined in the TAMP-domain language, such as Equation 2. For example, candidate plan skeleton 605 can include the sequence: Pick(r, o, g)→MoveFree(r, q₁, q₂)→Place(r, o, p), where r is a robot, o is an object, g is a grasp, and p is a placement pose. Candidate plan skeleton 605 can also include constraints, such as Kin(r, o, g) for forward kinematics, CFreeHold(r, o, g) to permit a collision-free motion while holding the object, and StablePlace(o,p) to verify stable placement, as well as cost expressions, such as TrajLength(q₁, q₂) to penalize longer motions or GraspQuality(g) to prefer more stable or reachable grasps. A candidate plan skeleton 605 π=(a₁, . . . , aₙ) induces a continuous CSP, where the goal is to assign values to the continuous parameters, such that all the constraints across a∈π, are satisfied. We denote the set of constraints across π as con(π)=U_{a∈π}, con(a), and the cost functions as cost(π)=U_{a∈π}, cost(a). In some embodiments, a CSP can be visualized as a constraint network, where nodes represent variables and constraints, and edges connect variables via the constraints. For example, in a task where robot 460 has to pick and place an object onto a surface, the free variables can include a starting configuration q₀, an intermediate configuration q₁, a grasp g, a placement pose p₁, and motion trajectories τ₁ and τ₂. The set of constraints can include motion feasibility between configurations, such as Motion(q₀, τ₁, q₁) and Motion(q₁, τ₂, q₂), collision-free trajectory constraints CFreeTraj (τ₁) and CFreeTraj(τ₂), kinematic reachability constraints for grasping and placing, such as Kin(q₁, obj, g, p₀) and Kin(q₂, obj, g, p₁), grasp feasibility Grasp(obj, g), placement stability StablePlace(obj, p₁, surface), and collision-free placement CFreePlace(obj, p₁). The variables can be linked through shared constraints, forming a graph structure that captures how geometric feasibility depends on the continuous assignments across the plan. In some embodiments, given a TAMP-domain representation 601, skeleton generator 611 generates candidate plan skeletons 605 by searching over symbolic actions whose preconditions and effects are defined in the domain. To guide the search, skeleton generator 611 converts state 602 into a symbolic abstraction of the current configuration of robot 460 and the surrounding environment, such as HandEmpty( ), AtPlacement(red,table1), or AtConf(qₛₜₐᵣₜ). Skeleton generator 611 also uses goal 503, which encodes the desired symbolic condition to be achieved, such as AtPlacement(red, bin) or On(obj, shelf) to guide the search. Using state 602 as the starting point, skeleton generator 611 performs symbolic planning by selecting actions whose preconditions match state 602 and whose effects move the system closer to satisfying goal 503. In some embodiments, skeleton generator 611 uses heuristics to prioritize one or more candidate plan skeletons 605, such as candidate plan skeletons 605 with fewer steps. For example, whenever robot 460 is not holding anything and the red block is on the table, and the goal is to place the red block in the bin, a candidate plan skeleton 605 can be Pick(red, g, table, q₁)→MoveHold(red, g, q₁, q₂, τ)→Place(red, g, bin, q₂). Whenever robot 460 is already holding the red block, the candidate plan skeleton can instead begin with MoveHold or even go directly to Place. In some embodiments, skeleton generator 611 uses a breadth-first (e.g., best-first) search approach that enumerates the countable set of candidate plan skeletons 605.

Particle initializer 612 processes candidate plan skeleton 605 and generates particles 606. Particles 606 are continuous parameter assignments corresponding to the symbolic structure of candidate plan skeleton 605. Each particle 606 includes values for all continuous variables in the candidate plan skeleton 605, such as robot joint configurations, grasp poses, object placements, trajectories, and/or the like. For example, given a skeleton containing the actions MoveFree (q₀, q₁,τ₁) and Pick(red, g, p₀, q₁), particle initializer 612 generate values for the free variables q₁, τ₁, and g. In some embodiments, particle initializer 612 includes a 6-DOF grasp sampler that takes the Grasp(red, g) constraint as input and generates a batch of grasp poses G in an object's frame. A conditional sampler for robot configurations then uses the grasps along with constraints such as Kin(q₁, red, g, p₀) and CFreeHold(red, g, q₁) to compute end-effector-consistent joint configurations Q₁ ∈ [symbol] ^{N}^{_{b}}^{×7} using a parallelized inverse kinematics solver. Then, a conditional trajectory sampler takes configurations q₀ and Q₁, along with constraints Motion(q₀, τ₁, q₁) and CFreeTraj (τ₁), and generates feasible trajectories τ₁ using linear interpolation, learned diffusion-based models, and/or the like. The trajectories are included in particles 606 that provide candidate continuous solutions for the candidate plan skeleton 605. In some embodiments, particle initializer 612 generates particles 606 by sampling a uniform distribution within predefined bounds (e.g., joint limits or workspace constraints), which can be used as a fallback when structured sampling is unavailable or as a baseline in optimization-based methods. In some embodiments, particle initializer 612 permits reusing sampled particles 606 across different candidate plan skeletons 605 that share common constraint subgraphs. For example, whenever a plurality of candidate plan skeletons 605 include overlapping actions or identical continuous subproblems, such as picking the same object from the same initial placement, reaching the same target configuration, and/or the like, the underlying constraint subgraphs often remain unchanged. To avoid repeated and unnecessary calls to samplers for the shared constraint subgraphs, particle initializer 612 caches the particle 606 outputs of individual samplers keyed by the constraint context and parameter bindings. When a new candidate plan skeleton 605 is encountered that includes a subgraph previously sampled (e.g., a Pick(red, gᵢ, pₒ, qᵢ) action with a known object and placement), particle initializer 612 retrieves the cached samples (e.g., particles) instead of resampling new particles 606.

Particle optimizer 613 processes particles 606 and candidate plan skeleton 605 and generates optimized particles 607. In various embodiments, particle optimizer 613 solves the CSP induced by candidate plan skeleton 605 π by reducing the CSP to an unconstrained optimization problem including the real-valued functions comprising each constraint and the cost functions across π. Let a parameter particle x=(x₁, x₂, . . . , x_{N}) be an assignment to the Nᵥ continuous variables in π. For each constraint c∈con(π), denote a differentiable real-valued function as J_{c} and tolerance as ∈_{c}. A constraint c is satisfied if J_{c}(x_{param (c)})≤∈_{c}, where x_{param (c)} denotes the subset of parameters in x that are relevant to c. For example, the kinematics constraint Kin(q₁, red, g, p₀) performs forward kinematics on the configuration q₁ of robot 460 and returns the pose error relative to the target pose p₀·g for object red. A particle 606 x is satisfying whenever the particle 606 satisfies all the constraints in 7f, and hence forms a valid solution to the CSP. In some examples, finding such a satisfying particle 606 corresponds to solving the mathematical program of Equation 4:

$${min}_{x} {\sum }_{{c}^{′} ∈ cost ( π )} {c}^{′} ( {x}_{param ( {c}^{′} )} ) subject to {J}_{c} ( {x}_{param ( c )} ) \leq {ϵ}_{c} ∀ c ∈ con ( π ) . \qquad ( Equation 4 )$$

Each candidate plan skeleton 605 induces a mathematical program, where the variables and costs are determined by the parameters, constraints, and costs of the actions included in candidate plan skeleton 605. In some examples, particle optimizer 613 solves the program described in Equation 4 by relaxing the hard constraints into soft costs, enabling the use of unconstrained optimization. The objective function is a weighted sum of the costs from the hard constraints and costs included in candidate plan skeleton 605, which can be viewed as soft constraints:

$${min}_{x} 𝒥 ( x ) = {\underbrace{{\sum }_{c ∈ c o n ( π )} {λ}_{c} \cdot {J}_{c} ( {x}_{param ( c )} )}}_{hard constraint costs} + {\underbrace{{\sum }_{{c}^{′} ∈ cost ( π )} {λ}_{{c}^{′}} \cdot {c}^{′} ( {x}_{param ( {c}^{′} )} )}}_{soft action costs} , \qquad ( Equation 5 )$$

where λ_{c} is the weight (e.g., constant penalty) for the corresponding constraint or cost c, which permits balancing the influence of a constraint or a cost. During the optimization process of Equation 5, particle optimizer 613 can check whether a particle 606 x satisfies the CSP by, for example, evaluating Equation 6:

$${∧}_{c ∈ c o n ( π )} {J}_{c} ( {x}_{param ( c )} ) \leq {ϵ}_{c} . \qquad ( Equation 6 )$$

In some embodiments, particle optimizer 613 uses parallelism to apply differentiable optimization and explore the parameter of particles 606 simultaneously. Denote a batch of N_{b} parameter particles 606 as [symbol] =(x₁, . . . , x_{N}_{_{b}}). In some examples, particle optimizer 613 minimizes the mean cost over all particles 606 in [symbol] according to Equation 7:

$${min}_{𝒫} {𝒥}_{b a t c h} ( 𝒫 ) = \frac{1}{{N}_{b}} {\sum }_{x ∈ 𝒫} 𝒥 ( x ) . \qquad ( Equation 7 )$$

In some embodiments, particle optimizer 613 generates optimized particles 607 by solving an unconstrained optimization problem, such as the one described in Equation 7, by iteratively updating the particles 606 [symbol] using a gradient-based optimizer. At each optimization step, particle optimizer 613 computes the cost function across the batch of particles 606. Whenever the cost function is differentiable, particle optimizer 613 computes the gradients of the cost with respect to the particles 606. The gradients are then used by a stochastic first-order optimizer, such as Adam, to update the parameters within each particle 606. In some embodiments, particle optimizer 613 uses other optimization approaches, including but not limited to augmented Lagrangians, coordinate descent, second-order optimizers, and/or the like. In various embodiments, particle optimizer 613 repeats gradient-descent updates to particles 606 until a stopping criterion has been met, such as a maximum optimization time, finding a satisfying particle 606 within the batch, and/or the like. In some embodiments, to optimize a batch of particles 606, particle optimizer 613 avoids summations, such as the summation in Equation 7, by first stacking the assignments of each continuous variable xᵢ across the batch of N_{b} particles 606 into a matrix Xᵢ. For example, if xᵢ ∈ [symbol] ⁷ represents a 7-DOF robot configuration, then Xᵢ ∈ [symbol] ^{N}^{_{b}}^{×7}. In order to compute the cost in Equation 5 across [symbol] batches of particles 606 simultaneously, particle optimizer uses vectorized versions of the cost functions. In some embodiments, particle optimizer 613 uses GPU acceleration to perform batched cost computation and gradient evaluation in parallel. For example, particle optimizer 613 can be implemented using any open-source machine learning framework, such as PyTorch, which enables automatic differentiation and efficient execution of cost functions on GPUs.

Feasibility checker 614 processes candidate plan skeletons 605 and optimized particles 607 and checks the feasibility of optimized particles 607. In some embodiments, feasibility checker 614 checks whether an optimized particle 607 is satisfying the constraints of the candidate plan skeleton 605 by comparing whether the costs corresponding to the constraints of candidate plan skeleton 605 falls within the pre-defined tolerances, such as described in Equation 3. Whenever feasibility checker 614 determines that there are no feasible particles 609, feasibility checker 614 prompts skeleton generator 611 to generate another candidate plan skeleton 605. In some embodiments, feasibility checker 614 estimates a feasibility measure of candidate plan skeleton 605 based on optimized particles 607. The feasibility measure, along with other factors, such as the length of candidate plan skeleton 605 are used to determine the order in which new candidate plan skeletons 605 should be generated. In some embodiments, feasibility checker 614 checks whether a subgraph included in candidate plan skeleton 605 is feasible by finding at least one counterexample out of the batch of N_{b} optimized particles 607. In some embodiments, feasibility checker 614 determines that a candidate plan skeleton 605 is infeasible, whenever at least one constraint included in candidate plan skeleton 605 has zero satisfying optimized particles 607. In some examples, feasibility checker 614 uses the heuristic of Equation 8 for the feasibility of a candidate plan skeleton 605 π with optimized particles 607 [symbol] :

$$H ( π , 𝒫 ) = \frac{1}{\vert co n ( π ) \vert} {\sum }_{c ∈ c o n ( π )} h ( 𝒫 , c ) where h ( 𝒫 , c ) = \{ \begin{matrix}{∧}_{penalty} & if {n}_{satisfying} = 0 , \\ {n}_{satisfying} & otherwise\end{matrix} \qquad ( Equation 8 )$$

n_{satisfying}=|J_{c}( [symbol] _{param (c)})≤∈_{c}| is the number of optimized particles 607 that satisfy constraint c, Λ_{penalty} denotes a large negative penalty applied when no optimized particle 607 in the batch satisfies constraint c. Intuitively, H(π, [symbol] ) measures the average feasibility of constraints across the candidate plan skeleton 605 by counting the number of optimized particles 607 satisfying each constraint and assigning a large penalty to constraints with no satisfying optimized particles 607, which can be quickly evaluated on a GPU. In some embodiments, when prompting skeleton generator 611 to generate a new candidate plan skeleton 605, feasibility checker 614 prunes candidate plan skeletons 605 with failed subgraphs by detecting candidate plan skeletons 605 that have the same pattern of failure as previously unsuccessfully generated candidate plan skeletons 605. In some embodiments, feasibility checker 614 determines that one or more constraints are likely unsatisfiable whenever the constraint has zero satisfying optimized particles 607 to prune candidate plan skeletons 605. Feasibility checker 614 then prunes new candidate plan skeletons 605 whenever the new candidate plan skeletons 605 include the unsatisfiable constraint subgraph. In some embodiments, because constraint unsatisfiability is intractable in general, whenever feasibility checker 614 finds at least one feasible particle 609 satisfying constraints, feasibility checker 614 returns all corresponding pruned candidate plan skeletons 605.

Plan assembler 615 processes plan skeleton 608 and feasible particle 609 and assembles robot plan 603. Plan assembler 615 combines plan skeleton 608 and feasible particle 609 by binding the continuous values from feasible particle 609 into the corresponding parameter slots in plan skeleton 608. For example, if plan skeleton 608 includes actions, such as Pick(red, g, table, q₁) and Place(red, g, bin, q₂), and feasible particle 609 assigns specific values to g, q₁, and q₂, plan assembler 615 generates a robot plan 603 that includes actions with continuous parameters ready for execution. In some embodiments, cuTAMP planner 447 maintains a priority queue of plan skeletons 608 and feasible particles 609 associated with plan skeletons 608. In some embodiments, each entry in the queue is scored according to a heuristic function that estimates the potential cost or feasibility of completing the plan. For example, the heuristic can consider factors, such as partial constraint satisfaction, estimated plan cost, or progress toward the goal 503. As feasible particles 609 are discovered through optimization, the associated skeleton-particle pairs remain in the queue and are re-ranked according to updated heuristic values. When assembling robot plan 603, plan assembler 615 selects the plan skeleton 608 from the queue that has at least one feasible particle 609 and the highest overall heuristic score. Robot plan 603 can then be passed to a motion controller to physically carry out at least part of a task. In some examples, the operation of cuTAMP planner 447 as a whole is described by Algorithm 1:

Algorithm 1: cuTAMP Algorithm

Require: TAMP problem Π, N_{b} particle 606 batch size, Nₛ number of candidate plan
skeletons 605

| | |
|---|---|
| 1: | Q ← [ ] [symbol] Initialize priority queue |
| 2: | for i = 1, ... , Nₛ do [symbol] Stage 1: Initialize candidate plan skeletons 605 and particles 606. |
| 3: | πᵢ ← SEARCHPLANSKELETON(Π) |
| 4: | [symbol] ᵢ ← InitializeParticles (πᵢ, N_{b}) [symbol] Parallelized Sampling |
| 5: | hᵢ ← PlanHeuristic(πᵢ, [symbol] ᵢ) |
| 6: | PuSH(Q, (hᵢ, πᵢ, [symbol] ᵢ)) |
| 7: | while Q ≠ [ ] do [symbol] Stage 2: Loop over candidate plan skeletons 605 and optimize. |
| 8: | (h, π, [symbol] ) ← POP(Q) |
| 9: | [symbol] ′ ← OPTIMIZEPARTICLES(π, [symbol] ) [symbol] Parallelized Optimization |
| 10: | if IsGoalSatisfied(π, [symbol] ′) then |
| 11: | return π, GetSAtisfyingParticles (π, [symbol] ′) |
| 12: | for i = 1, ... , Nₛ do [symbol] Sample additional candidate plan skeletons 605 |
| 13: | π_{new} ← SEARCHPLANSKELETON(Π) |
| 14: | [symbol] _{new} ← InitializeParticles (π_{new} , N_{b}) |
| 15: | h_{new} ← PLANHEURISTIC(π_{new} , [symbol] _{new} ) |
| 16: | PUSH(Q, (h_{new} , π_{new} , [symbol] _{new} )) |
| 17: | h′ ← PlanHeuristic(π, [symbol] ′) |
| 18: | PuSh(Q, (h′, π, [symbol] ′)) [symbol] Add back to queue |
| 19: | return FAILURE |

FIG. 7 is a more detailed illustration of the TAMP-domain language parser 446, according to various embodiments. As shown, TAMP-domain language parser 446 includes, without limitation, a parser and static checker 711, a constraint graph builder 712, a subgraph tagger 713, and a representation generator 714. In operation, parser and static checker 711 processes TAMP-domain language input 501 and generates abstract syntax tree 701, based on TAMP-domain language data 424. Constraint graph builder 712 processes abstract syntax tree 701 and generates constraint graph templates 702. Subgraph tagger 713 processes constraint graph templates 702 and generates subgraph tag metadata 703, based on subgraph classification rules 425. Representation generator 714 processes constraint graph templates 702 and subgraph tag metadata 703 and generates TAMP-domain representation 601.

Parser and static checker 711 processes TAMP-domain language input 501 and generates abstract syntax tree 701, based on TAMP-domain language data 424. TAMP-domain language data 424 defines the symbolic and continuous modeling components for a TAMP domain. In some embodiments, TAMP-domain language data 424 includes types, predicates, constraints, and action schemas that together specify how robots, objects, and the environment are represented and manipulated. The types in TAMP-domain language data 424 include symbolic and continuous elements: conf for robot configurations, traj for robot trajectories (e.g., sequences of configurations), obj for manipulable objects, grasp for object grasp poses, placement for object placement poses, surface for placement surfaces, button for buttons that can be pressed, press for poses at which a button can be pressed, and/or the like. The types are extensible, and additional continuous elements can be incorporated into the TAMP-domain representation without modifying the underlying TAMP-domain language structure. For example, types can include joint angles of articulated structures, such as cabinet hinges, drawer sliders, or robotic gripper fingers, and support modeling of push or pull actions, latching mechanisms, or compliant interactions. The extensibility further enables modeling of hybrid systems beyond robotics, such as fluid levels in tanks, valve positions in process control systems, or thruster configurations in aerospace applications, such as rockets. The predicates specify symbolic conditions about the environment and robot 460. The predicates include AtConf(q: conf), indicating that robot 460 is at configuration q; HandEmpty ( ), indicating that the gripper of robot 460 is currently empty; AtPlacement(o: obj,p: placement), indicating that object o is placed at pose p; Holding(o: obj, g: grasp), indicating that object O is currently grasped using grasp pose g; On(o: obj, s: surface), indicating that object O is placed on top of surface s; IsStick (o: obj), indicating that object O is a stick that can be used to press buttons; and Pressed(b: button), indicating that button b has been successfully pressed. Constraints describe real-valued geometric or physical conditions that have to be satisfied by actions. The constraints include Motion (q₁: conf, τ: traj, q₂: conf), a constraint requiring that trajectory τ connects configurations q₁ and q₂ within robot joint limits; Kin(q: conf, o: obj, g: grasp, p: placement), requiring that configuration q satisfies an inverse kinematics constraint with respect to object o grasped at g and placed at p; Grasp(o: obj, g: grasp), requiring that g is a valid grasp pose for object O; StablePlace(o: obj, p: placement, s: surface), requiring that placement p is stable for object O on surface s; CFreeTraj(τ: traj), requiring that trajectory τ is collision-free; CFreeHold(o: obj, g: grasp, q: conf), requiring that grasp g is collision-free at configuration q; CFreeTrajHold(o: obj,g: grasp, τ: traj), requiring that τ is collision-free while holding object O with grasp g; CFreePlace(o: obj, p: placement), requiring that placing object O at placement p does not result in collisions; ValidPress(b: button, p: press, q: conf), requiring that pose p and configuration q form a valid pressing motion onto button b; and ValidStickPress(o: obj, g: grasp, p: press, b: button), requiring that object o, grasp g, and pose p result in a successful stick-assisted press of button b. The action schemas define the set of symbolic actions available for TAMP. The action schemas include MoveFree (q₁: conf, q₂: conf, τ: traj), which moves robot 460 freely from configuration q₁ to q₂ along trajectory τ; Pick(o: obj, g: grasp, p: placement, q: conf), which picks object O at placement p with grasp g and configuration q; MoveHolding(o: obj, g: grasp, q₁: conf, q₂: conf, τ: traj), which moves robot 460 from q₁ to q₂ while holding object O with grasp g; Place(o: obj, g: grasp, p: placement, s: surface, q: conf), which places object o held with grasp g onto surface s at placement pose p using configuration q; PressButton(b: button, p: press, q: conf), which presses button b using pose p and configuration q; and PressButtonStick(b: button, o: obj, g: grasp, p: press, q: conf), which presses button b using a stick object o held with grasp g at pose p and configuration q. In some embodiments, parser and static checker 711 analyzes the structure of the TAMP-domain language input 501 to determine that the input conforms to the expected syntactic and semantic rules specified in TAMP-domain language data 424. In some embodiments, the parsing step identifies and extracts declarations of types, predicates, constraints, and action schemas, mapping types, predicates, constraints, and action schemas into a hierarchical tree structure where nodes represent syntactic constructs, such as type definitions, predicate signatures, constraint specifications, and action parameters. For example, each action schema node in abstract syntax tree 701 can include child nodes corresponding to the action's parameter list, preconditions (e.g., predicates), constraints (e.g., continuous feasibility requirements), and cost terms. Similar to action schema, constraint nodes included in abstract syntax tree 701 include the relationships between variables and the functional forms the variables impose. In some embodiments, parser and static checker 711 uses static checking to verify that all referenced types, predicates, and constraints are valid according to TAMP-domain language data 424 so that, for example, only declared types are used as parameters and that constraints reference appropriate variable bindings. For example, a TAMP-domain language input 501 can define an action Pick(o: obj, g: grasp, p: placement, q: conf) with preconditions [HandEmpty( ), AtPlacement(o, p), AtConf(q)], constraints [Kin(q, o, g, p), Grasp(o, g), CFreeHold(o, g, q)], and an optional cost term [TrajLength(q)]. The corresponding abstract syntax tree 701 could have a top-level node labeled Pick with child nodes representing the parameters (o, g, p, q), a Preconditions node containing HandEmpty,AtPlacement, and AtConf subnodes, a Constraints node containing Kin, Grasp, and CFreeHold subnodes, and a Cost node containing TrajLength. Each node further contains references to the types and variables involved, thereby capturing the full syntactic and semantic structure of the action.

Constraint graph builder 712 processes abstract syntax tree 701 and generates constraint graph templates 702. In some embodiments, constraint graph builder 712 analyzes the hierarchical structure encoded in abstract syntax tree 701, particularly the action parameters, constraints, and cost expressions, and constructs a template-level graph-based representation, in which nodes correspond to symbolic and continuous variables and constraints, and edges capture the dependencies between variables introduced by the constraints. In some embodiments, each continuous variable (e.g., robot configuration, grasp pose, placement pose, trajectory) is represented as a node, and each constraint (e.g., Kin, CFreeTraj, StablePlace) is also represented as a node. An edge is created between a variable node and a constraint node whenever the variable appears as an argument to the constraint. For example, when a Kin(q, o, g, p) constraint includes variables q, o, g, and p, then constraint graph 702 includes edges connecting the Kin constraint node to each of the q, o, g, and p variable nodes. Similar to constraints, cost functions included in the abstract syntax tree 701 are mapped into cost nodes connected to the relevant continuous variables. The resulting constraint graph templates 702 define reusable constraint structures that can be instantiated based on a candidate plan skeleton 605.

Subgraph tagger 713 processes constraint graph 702 and generates subgraph tag metadata 703, based on subgraph classification rules 425. In some embodiments, subgraph tagger 713 analyzes the structure of constraint graph templates 702 to identify groups of related constraints and variables that can be treated as coherent subproblems during sampling and optimization in TAMP. In some embodiments, subgraph tagger 713 uses subgraph classification rules 425, which define templates or patterns specifying which combinations of constraints and variable types should be grouped together under a common tag. For example, subgraph classification rules 425 can include that a Kin(q, o, g, p) constraint together with associated Grasp(o, g) and CFreeHold(o, g, q) constraints define a “Grasp IK” subgraph, while a combination of StablePlace(o, p, s) and CFreePlace(o, p) defines a “Placement Stability” subgraph. In some embodiments, subgraph tagger 713 traverses constraint graph templates 702, matches local neighborhoods of constraints and variables against subgraph classification rules 425, and whenever a match is found, assigns a subgraph tag to the group of constraints and associated variables that satisfy the matched subgraph classification rule 425. In some embodiments, subgraph tagger 713 prioritizes matching larger subgraphs first or prefer tags associated with commonly sampled structures. Tagged graph 703 retains the full topology of constraint graph 702 but further adds to constraint graph 702 with metadata annotations (e.g., tags) that identify reusable and semantically meaningful subgraphs. Subgraph tag metadata 703 captures the tagging results and may retain the structure of constraint graph templates 702 along with metadata annotations (e.g., tags) that identify reusable and semantically meaningful subgraphs.

Representation generator 714 processes constraint graph templates 702 and subgraph tag metadata 703 and generates TAMP-domain representation 601. In some embodiments, representation generator 714 processes constraint graph templates 702 and subgraph tag metadata 703 and serializes the structure of the TAMP domain, including variables, constraints, subgraph tags, and associated metadata, into a machine-readable format suitable for downstream consumption by the cuTAMP planner 447. In some embodiments, the serialization process includes listing the variables with variable types (e.g., conf, traj, obj, grasp, placement), the constraints applied to each variable or group of variables (e.g., Kin, CFreeTraj, StablePlace), and the subgraph tags identifying reusable or jointly optimizable components. In various embodiments, representation generator 714 preserves the connectivity between variables and constraints as defined in constraint graph templates 702 and incorporates tagging structure from subgraph tag metadata 703. In some embodiments, TAMP-domain representation 601 is generated in a structured format such as JSON, Protocol Buffers, or a similar serialization framework that permits processing by cuTAMP planner 447. TAMP-domain representation 601 provides a compact description of the symbolic and continuous TAMP-domain problem, including both the logical dependencies and the geometric feasibility conditions required to generate executable robot plan 603.

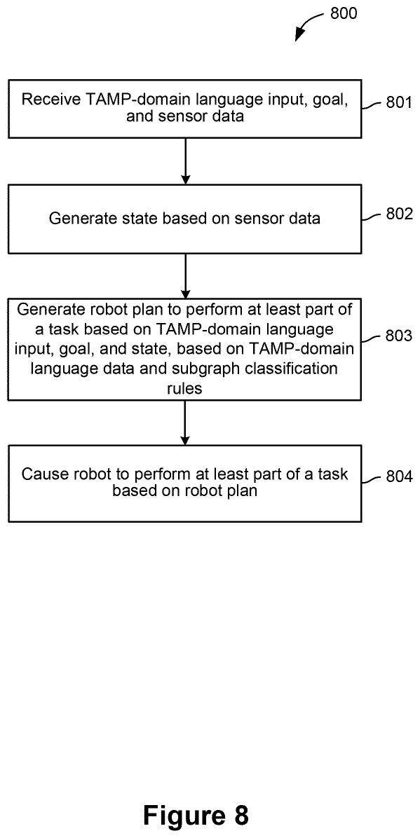

FIG. 8 is a flow diagram of method steps for controlling robot 460, according to various embodiments. Although the method steps are described in conjunction with the systems of FIGS. 1-7, persons skilled in the art will understand that any system configured to perform the method steps in any order falls within the scope of the present disclosure.

As shown, a method 800 begins with step 801, wherein robot control application 448 receives TAMP-domain language input 501, goal 503, and sensor data 502. In some embodiments, robot control application 448 receives TAMP-domain language input 501 and goal 503 via one or more I/O devices, from a user (e.g., through a graphical interface or command-line input), from another software application module (e.g., a task assignment service or mission planner), or from an external system over network 430 (e.g., via an Application Programming Interface or cloud-based orchestration service), and/or the like. In some embodiments, robot control application 448 receives sensor data 502 from sensors 480.

At step 802, robot control application 448 generates state 602 based on sensor data 502. In some embodiments, robot control application 448 includes a perception module which processes sensor data 502 to extract information about the current state of the environment and robot 460. Robot control application 448 uses the state information to determine which symbolic conditions apply and to compute specific values for variables used in TAMP. For example, the perception module can process a camera feed to determine that a red cube is located at position (x, y, z) on the table, which can then be translated into symbolic predicates (e.g., At(red_cube, table)) and associated continuous parameters (e.g., placement_pose_red_cube) in terms of TAMP-domain language input 501.

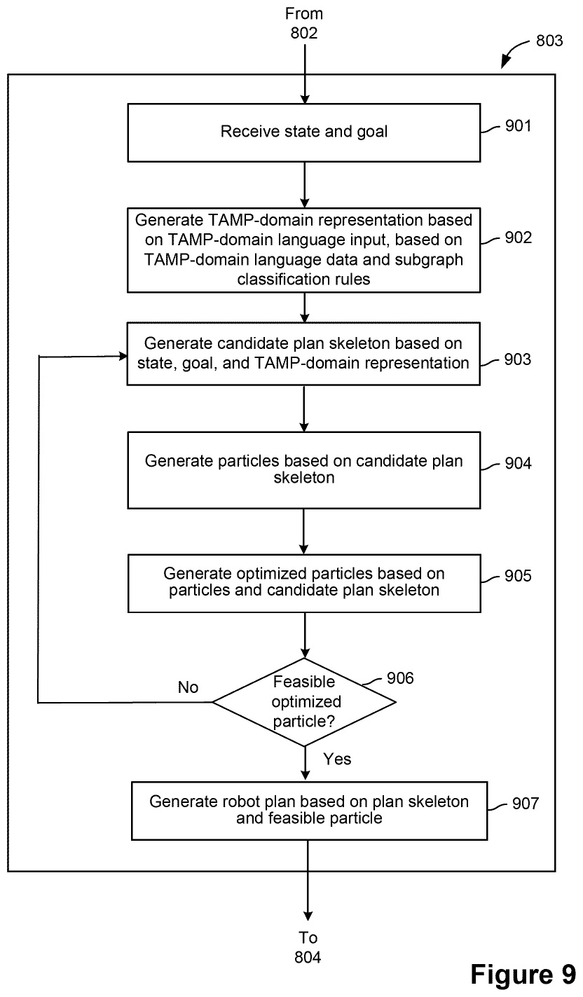

At step 803, robot control application 448 generates robot plan 603 to perform at least part of a task based on TAMP-domain language input 501, goal 503, and state 602, based on TAMP-domain language data 424 and subgraph classification rules 425. Step 803 is described in greater detail in conjunction with FIG. 9.

At step 804, robot control application 448 causes robot 460 to perform at least part of a task based on robot plan 603. In some embodiments, robot control application 448 uses any suitable control and motion planning techniques to process robot plan 603 and generate one or more control signals for robot 460. For example, robot control application 448 can use inverse kinematics solvers, trajectory interpolation, MPC, feedback-based motion controllers, and/or the like, to compute motor commands that cause robot 460 to execute robot plan 603.

FIG. 9 is a flow diagram of method steps for generating robot plan 603, according to various embodiments. Although the method steps are described in conjunction with the systems of FIGS. 1-7, persons skilled in the art will understand that any system configured to perform the method steps in any order falls within the scope of the present disclosure.

As shown, the step 803 of the method 800 begins with step 901, where cuTAMP planner 447 receives state 602 and goal 503. In some embodiments, cuTAMP planner 447 receives goal 503 via one or more I/O devices, a user interface, another software module, a remote system over network 430, from stored task specifications in memory 444, and/or the like. In some embodiments, cuTAMP planner 447 receives state 602 generated in step 802.

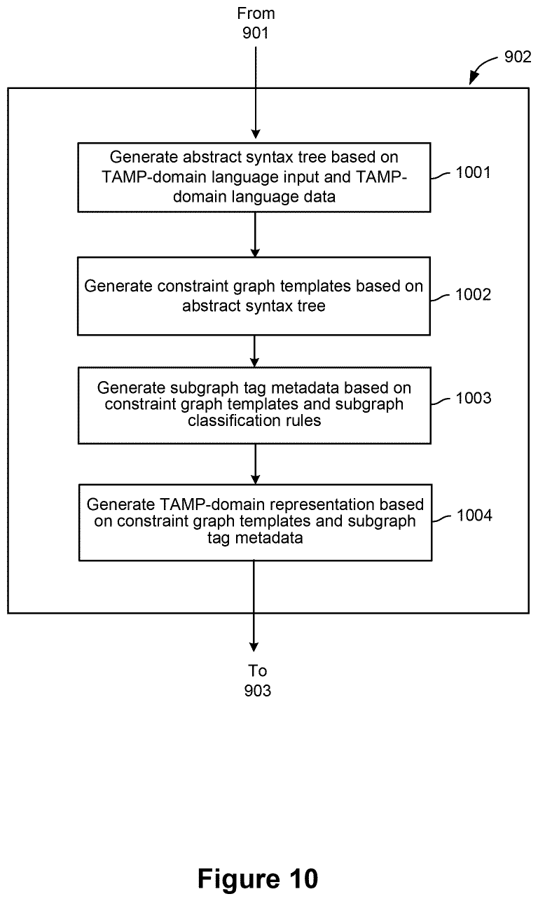

At step 902, TAMP-domain language parser 446 generates TAMP-domain representation 601 based on TAMP-domain language input 501, based on TAMP-domain language data 424 and subgraph classification rules 425. Step 902 is described in greater detail in conjunction with FIG. 10.

At step 903, skeleton generator 611 generates candidate plan skeleton 605 based on state 602, goal 503, and TAMP-domain representation 601. Given a TAMP-domain representation 601, skeleton generator 611 generates candidate plan skeletons 605 by searching over symbolic actions whose preconditions and effects are defined in the domain. To guide the search, skeleton generator 611 converts state 602 into a symbolic abstraction of the current configuration of robot 460 and the surrounding environment, such as HandEmpty( ), AtPlacement(red, table1), orAtConf(qₛₜₐᵣₜ). Skeleton generator 611 also uses goal 503, which encodes the desired symbolic condition to be achieved, such as AtPlacement(red, bin) or On(obj, shelf), to guide the search. Using state 602 as the starting point, skeleton generator 611 performs symbolic planning by selecting actions whose preconditions match state 602 and whose effects move the system closer to satisfying goal 503. In some embodiments, skeleton generator 611 uses heuristics to prioritize one or more candidate plan skeletons 605, such as candidate plan skeletons 605 with fewer steps. In some embodiments, skeleton generator 611 uses a breadth-first (e.g., best-first) search approach that enumerates the countable set of candidate plan skeletons 605.

At step 904, particle initializer 612 generates particles 606 based on candidate plan skeleton 605. In some embodiments, particle initializer 612 generates particles 606 by sampling a uniform distribution within predefined bounds (e.g., joint limits or workspace constraints), which can be used as a fallback when structured sampling is unavailable or as a baseline in optimization-based methods. In some embodiments, particle initializer 612 permits reusing sampled particles 606 across different candidate plan skeletons 605 that share common constraint subgraphs. For example, whenever a plurality of candidate plan skeletons 605 include overlapping actions or identical continuous subproblems, such as picking the same object from the same initial placement, reaching the same target configuration, and/or the like, the underlying constraint subgraphs often remain unchanged. To avoid repeated and unnecessary calls to samplers for the shared constraint subgraphs, particle initializer 612 caches the particle 606 outputs of individual samplers keyed by the constraint context and parameter bindings. When a new candidate plan skeleton 605 is encountered that includes a subgraph previously sampled, particle initializer 612 retrieves the cached samples (e.g., particles) instead of resampling new particles 606. As an example, particle initializer 612 includes a 6-DOF grasp sampler that takes the Grasp(red, g) constraint as input and generates a batch of grasp poses G in an object's frame. A conditional sampler for robot configurations then uses the grasps along with constraints, such as Kin(q₁, red, g, pₒ) and CFreeHold(red, g, q₁) to compute end-effector-consistent joint configurations Q₁ ∈ [symbol] ^{N}^{_{b}}^{×7} using a parallelized inverse kinematics solver. Then, a conditional trajectory sampler takes configurations q₀ and Q₁, along with constraints Motion(q₀,τ₁, q₁) and CFreeTraj (τ₁), and generates feasible trajectories τ₁ using linear interpolation, learned diffusion-based models, and/or the like. The trajectories are included in particles 606 that provide candidate continuous solutions for the candidate plan skeleton 605.

At step 905, particle optimizer 613 generates optimized particles 607 based on particles 606 and candidate plan skeleton 605. In various embodiments, particle optimizer 613 solves the CSP induced by candidate plan skeleton 605 by reducing the CSP to an unconstrained optimization problem including the real-valued functions comprising each constraint and the cost functions across the candidate plan skeleton 605. In some examples, finding such a satisfying particle 606 corresponds to solving the mathematical program of Equation 4. Each candidate plan skeleton 605 induces a mathematical program, where the variables and costs are determined by the parameters, constraints, and costs of the actions included in candidate plan skeleton 605. In some examples, particle optimizer 613 solves the program described in Equation 4 by relaxing the hard constraints into soft costs, enabling the use of unconstrained optimization. The objective function is a weighted sum of the costs from the hard constraints and costs included in candidate plan skeleton 605, which can be viewed as soft constraints as described by Equation 5. During the optimization process of Equation 5, particle optimizer 613 checks whether a particle 606 satisfies the CSP by, for example, evaluating Equation 6. In some embodiments, particle optimizer 613 uses parallelism to apply differentiable optimization and explore the parameter of particles 606 simultaneously. In some examples, particle optimizer 613 minimizes the mean cost over all particles 606 in a batch according to Equation 7. In some embodiments, particle optimizer 613 generates optimized particles 607 by solving an unconstrained optimization problem, such as the one described in Equation 7, by iteratively updating the particles 606 using a gradient-based optimizer. At each optimization step, particle optimizer 613 computes the cost function across the batch of particles 606 (e.g., batch cost computation). Whenever the cost function is differentiable, particle optimizer 613 computes the gradients of the cost with respect to the particles 606. The gradients are then used by a stochastic first-order optimizer, such as Adam, to update the parameters within each particle 606. In some embodiments, particle optimizer 613 uses other optimization approaches, including but not limited to augmented Lagrangians, coordinate descent, second-order optimizers, and/or the like. In various embodiments, particle optimizer 613 repeats gradient-descent updates to particles 606 until a stopping criterion has been met, such as a maximum optimization time, finding a satisfying particle 606 within the batch, and/or the like. In some embodiments, to optimize a batch of particles 606, particle optimizer 613 avoids summations, such as the summation in Equation 7, by first stacking the assignments of each continuous variable across the batch of particles 606 into a matrix. In order to compute the cost in Equation 5 across batches of particles 606 simultaneously, particle optimizer uses vectorized versions of the cost functions. In some embodiments, particle optimizer 613 uses GPU acceleration to perform batched cost computation and gradient evaluation in parallel. For example, particle optimizer 613 can be implemented using any open-source machine learning framework, such as PyTorch, which enables automatic differentiation and efficient execution of cost functions on GPUs.

At step 906, feasibility checker 614 checks the feasibility of optimized particles 607. Feasibility checker 614 checks whether an optimized particle 607 is satisfying the constraints of the candidate plan skeleton 605 by comparing whether the costs corresponding to the constraints of candidate plan skeleton 605 falls within the pre-defined tolerances, such as described in Equation 3. Whenever feasibility checker 614 determines that there are no feasible particles 609, feasibility checker 614 prompts skeleton generator 611 to generate another candidate plan skeleton 605. In some embodiments, feasibility checker 614 estimates a feasibility measure of candidate plan skeleton 605 based on optimized particles 607. The feasibility measure, along with other factors, such as the length of candidate plan skeleton 605 are used to determine the order in which new candidate plan skeletons 605 should be generated. In some embodiments, feasibility checker 614 checks whether a subgraph included in candidate plan skeleton 605 is feasible by finding at least one counterexample out of the batch of optimized particles 607. In some embodiments, feasibility checker 614 determines that a candidate plan skeleton 605 is infeasible, whenever at least one constraint included in candidate plan skeleton 605 has zero satisfying optimized particles 607. In some examples, feasibility checker 614 uses the heuristic of Equation 8 for the feasibility of a candidate plan skeleton 605 with optimized particles 607. In some embodiments, when prompting skeleton generator 611 to generate a new candidate plan skeleton 605, feasibility checker 614 prunes candidate plan skeletons 605 with failed subgraphs by detecting candidate plan skeletons 605 that have the same pattern of failure as previously unsuccessfully generated candidate plan skeletons 605. Whenever feasibility checker 614 determines the existence of at least one feasible optimized particle 607, the step 803 of the method 800 proceeds to step 907. Whenever feasibility checker 614 determines the non-existence of at least one feasible optimized particle 607, the step 803 of the method 800 returns to step 903 where feasibility checker 614 prompts skeleton generator 611 to generate a new candidate plan skeleton 605.

At step 907, plan assembler 615 generates robot plan 603 based on plan skeleton 608 and feasible particle 609. In some embodiments, plan assembler 615 combines plan skeleton 608 and feasible particle 609 by binding the continuous values from feasible particle 609 into the corresponding parameter slots in plan skeleton 608. In some embodiments, cuTAMP planner 447 maintains a priority queue of plan skeletons 608 and feasible particles 609 associated with plan skeletons 608. In some embodiments, each entry in the queue is scored according to a heuristic function that estimates the potential cost or feasibility of completing the plan. For example, the heuristic can consider factors, such as partial constraint satisfaction, estimated plan cost, or progress toward the goal 503. As feasible particles 609 are discovered through optimization, the associated skeleton-particle pairs remain in the queue and are re-ranked according to updated heuristic values. When assembling robot plan 603, plan assembler 615 selects the plan skeleton 608 from the queue that has at least one feasible particle 609 and the highest overall heuristic score. In some examples, the operation of cuTAMP planner 447 as a whole is described by Algorithm 1:

FIG. 10 is a flow diagram of method steps for generating a TAMP-domain representation 601, according to various embodiments. Although the method steps are described in conjunction with the systems of FIGS. 1-7, persons skilled in the art will understand that any system configured to perform the method steps in any order falls within the scope of the present disclosure.

As shown, the step 902 of the method 800 begins with step 1001, where parser and static checker 711 generates abstract syntax tree 701 based on TAMP-domain language input 501 and TAMP-domain language data 424. In some embodiments, parser and static checker 711 analyzes the structure of the TAMP-domain language input 501 to determine that the input conforms to the expected syntactic and semantic rules specified in TAMP-domain language data 424. In some embodiments, the parsing step identifies and extracts declarations of types, predicates constraints, and action schemas, mapping types, predicates, constraints, and action schemas into a hierarchical tree structure where nodes represent syntactic constructs, such as type definitions, predicate signatures, constraint specifications, and action parameters. In some embodiments, parser and static checker 711 uses static checking to verify that all referenced types, predicates, and constraints are valid according to TAMP-domain language data 424.

At step 1002, constraint graph builder 712 generates constraint graph templates 702 based on abstract syntax tree 701. In some embodiments, constraint graph builder 712 analyzes the hierarchical structure encoded in abstract syntax tree 701, particularly the action parameters, constraints, and cost expressions, and constructs a template-level graph-based representation. In the graph-based representation, nodes correspond to symbolic and continuous variables and constraints and edges capture the dependencies between variables introduced by the constraints. In some embodiments, each continuous variable (e.g., robot configuration, grasp pose, placement pose, trajectory) is represented as a node, and each constraint (e.g., Kin, CFreeTraj, StablePlace) is also represented as a node. An edge is created between a variable node and a constraint node whenever the variable appears as an argument to the constraint. Similar to constraints, cost functions included in the abstract syntax tree 701 are mapped into cost nodes connected to the relevant continuous variables. The resulting constraint graph templates 702 define reusable constraint structures that can be instantiated based on a candidate plan skeleton 605.

At step 1003, subgraph tagger 713 generates subgraph tag metadata 703 based on constraint graph 702 and subgraph classification rules 425. In some embodiments, subgraph tagger 713 analyzes the structure of constraint graph templates 702 to identify groups of related constraints and variables that can be treated as coherent subproblems during sampling and optimization in TAMP. In some embodiments, subgraph tagger 713 uses subgraph classification rules 425, which define templates or patterns specifying which combinations of constraints and variable types should be grouped together under a common tag. Subgraph tagger 713 traverses constraint graph templates 702, matches local neighborhoods of constraints and variables against subgraph classification rules 425, and whenever a match is found, assigns a subgraph tag to the matching set. In some embodiments, subgraph tagger 713 prioritizes matching larger subgraphs first or prefer tags associated with commonly sampled structures. Tagged graph 703 retains the full topology of constraint graph 702 but further adds to constraint graph 702 with metadata annotations (e.g., tags) that identify reusable and semantically meaningful subgraphs.

At step 1004, representation generator 714 generates TAMP-domain representation 601 based on constraint graph templates 702 and subgraph tag metadata 703. Representation generator 714 processes constraint graph templates 702 and subgraph tag metadata 703 and serializes the structure of the TAMP domain, including variables, constraints, subgraph tags, and associated metadata, into a machine-readable format suitable for downstream consumption by the cuTAMP planner 447. The serialization process includes listing the variables with variable types (e.g., conf, traj, obj, grasp, placement), the constraints applied to each variable or group of variables (e.g., Kin, CFreeTraj, StablePlace), and the subgraph tags identifying reusable or jointly optimizable components. In various embodiments, representation generator 714 preserves the connectivity between variables and constraints as defined in constraint graph templates 702 and incorporates tagging structure from subgraph tag metadata 703. In some embodiments, TAMP-domain representation 601 is generated in a structured format such as JSON, Protocol Buffers, or a similar serialization framework that permits processing by cuTAMP planner 447.

In sum, techniques are disclosed for robot control based on differentiable TAMP. In various embodiments, the disclosed techniques include a TAMP-domain language parser. The TAMP-domain language parser processes a TAMP-domain language input and generates a TAMP-domain representation based on TAMP-domain language data and subgraph classification rules. The TAMP-domain language input includes both symbolic elements, such as types, predicates, and actions, and continuous geometric constraints and cost expressions associated with the actions. The TAMP-domain language parser includes a parser and static checker, a constraint-graph builder, a subgraph tagger, and a representation generator. The parser and static checker processes the TAMP-domain language input and TAMP-domain language data and generates an abstract syntax tree, which encodes the hierarchical structure of the domain, which includes actions, parameters, constraints, and cost expressions. The constraint-graph builder processes the abstract syntax tree and generates constraint graph templates, representing reusable parameterized constraint structures associated with each action schema. The subgraph tagger processes the constraint graph templates and the subgraph classification rules and generates subgraph tag metadata, which identifies reusable groups of constraints, such as inverse kinematics, grasp feasibility, or placement stability. The representation generator processes the constraint graph templates and subgraph tag metadata and generates a TAMP-domain representation by serializing the associated metadata into a machine-readable format. The TAMP-domain representation can be processed by any TAMP planner along with state and goal information to generate a robot plan, which causes a robot to perform at least part of a task. In some embodiments, the disclosed techniques include a cuTAMP planner which processes the TAMP-domain representation, state, and goal information and generates a robot plan. In various embodiments, the cuTAMP planner includes a skeleton generator, a particle initializer, a particle optimizer, a feasibility checker, and a plan assembler. The skeleton generator processes the TAMP-domain representation, the state, and the goal and generates a candidate plan skeleton. The particle initializer processes the plan skeleton to generate plan particles. The particle optimizer processes the plan particles and candidate plan skeleton and generates optimized particles. The feasibility checker checks whether one or more optimized particles are feasible based on the plan skeleton and ranks optimized plan particles based on heuristics. Whenever one or more feasible particles are found, the plan assembler assembles the candidate plan skeleton and the feasible particle with the highest rank into a robot plan. Whenever a feasible particle is not found, cuTAMP planner prompts the skeleton generator to generate another candidate plan skeleton and the process repeats until a feasible particle is found. The robot plan can be used by a robot control application to cause a robot to perform at least part of a task.

At least one technical advantage of the disclosed techniques relative to the prior art is that the disclosed techniques use sampling, optimization, and symbolic planning into a unified TAMP framework, thereby improving coordination between symbolic plan structures and continuous feasibility constraints. Unlike conventional approaches that treat sampling and optimization as isolated processes, the disclosed techniques generate and evaluate candidate plan skeletons using particle-based initialization and differentiable optimization, permitting continuous constraints, such as kinematics, collision avoidance, and stability, to be addressed jointly across the robot plan. Furthermore, by using a heuristic-driven priority queue to rank plan skeletons based on particle-based feasibility estimates, the disclosed techniques allocate computational resources to plan skeletons that are more likely to yield viable robot plans, avoiding wasted computation on plan skeletons that are infeasible. These technical advantages provide one or more technological improvements over prior art approaches.
1. In some embodiments, a computer-implemented method for controlling a robot comprises receiving a task and motion planning (TAMP)-domain language input comprising one or more symbolic elements and one or more continuous elements, generating a TAMP-domain representation based on the TAMP-domain language input, TAMP-domain language data, and one or more subgraph classification rules, generating a robot plan based on the TAMP-domain representation, a state, and a goal, and causing the robot to perform at least part of the robot plan.
2. The computer-implemented method of clause 1, wherein the continuous elements comprise at least one of one or more robot configurations, one or more manipulable objects, one or more placement poses of the one or more manipulable objects, one or more placement surfaces, one or more buttons, or one or more poses at which the one or more buttons can be pressed.
3. The computer-implemented method of clauses 1 or 2, wherein the symbolic elements comprise at least one of a first predicate for the robot being at a configuration, a second predicate for a gripper of the robot being empty, a third predicate for an object being at a pose, a fourth predicate for the object being at a grasped pose, a fifth predicate for the object being placed on a surface, a sixth predicate for the object being a stick that can be used to press one or more buttons, or a seventh predicate for confirming that the one or more buttons are pressed.
4. The computer-implemented method of any of clauses 1-3, wherein the TAMP-domain language data comprises at least one of one or more types, one or more predicates, one or more constraints, or one or more action schemas.
5. The computer-implemented method of any of clauses 1-4, wherein the one or more constraints comprise at least one of a constraint to connect a trajectory between a first configuration and a second configuration, a constraint for a robot configuration to satisfy inverse kinematics with respect to an object grasped at a first pose and placed at a second pose, a constraint to satisfy a valid grasp pose for an object, a constraint for stable placement of an object on a surface, one or more constraints for a collision-free trajectory, or a constraint for valid pressing motion onto a button.
6. The computer-implemented method of any of clauses 1-5, wherein the one or more action schemas comprise at least one of a first action schema to move the robot freely from a first configuration to a second configuration along a trajectory, a second action schema to pick an object at a placement pose with a grasp and a third configuration, a third action schema to move the robot from the first configuration to the second configuration while holding the object with the grasp, a fourth action schema to place the object held at the grasp on a surface at the placement pose using the third configuration, a fifth action schema to press a button using a pose and a fourth configuration, or a sixth action schema to press the button using a stick object held at the grasp and the pose and a fifth configuration.
7. The computer-implemented method of any of clauses 1-6, wherein generating the TAMP-domain representation comprises generating, based on the TAMP-domain language input and the TAMP-domain language data, an abstract syntax tree (AST), generating, based on the AST, one or more constraint graph templates, generating, based on the one or more constraint graph templates and the one or more subgraph classification rules, subgraph tag metadata, and generating, based on the one or more constraint graph templates and the subgraph tag metadata, the TAMP-domain representation.
8. The computer-implemented method of any of clauses 1-7, wherein the one or more constraint graph templates comprises at least one of one or more first nodes representing one or more symbolic variables, one or more second nodes representing one or more continuous variables, one or more third nodes representing one or more constraints, one or more cost nodes representing one or more cost functions defined over the one or more continuous variables, or one or more edges to capture one or more dependencies based on the one or more constraints and at least one of the one or more symbolic variables or the one or more continuous variables, wherein each edge included in the one or more edges connects at least one of a symbolic variable included in the one more symbolic variables or a continuous variable included in the one or more continuous variables to at least one of a constraint node included in the one or more third nodes or a cost node included in the one or more cost nodes.
9. The computer-implemented method of any of clauses 1-8, wherein generating the subgraph tag metadata comprises identifying one or more groups of one or more related constraints and one or more related variables.
10. The computer-implemented method of any of clauses 1-9, wherein generating the subgraph tag metadata comprises prioritizing at least one of one or more larger subgraphs included in the one or more constraint graph templates or one or more commonly sampled subgraphs included in the one or more constraint graph templates.
11. In some embodiments, one or more non-transitory computer-readable media store instructions that, when executed by one or more processors, cause the one or more processors to perform the steps of receiving a TAMP-domain language input comprising one or more symbolic elements and one or more continuous elements, generating a TAMP-domain representation based on the TAMP-domain language input, TAMP-domain language data, and one or more subgraph classification rules, generating a robot plan based on the TAMP-domain representation, a state, and a goal, and causing a robot to perform at least part of the robot plan.
12. The one or more non-transitory computer-readable media of clause 11, wherein the continuous elements comprise at least one of one or more robot configurations, one or more manipulable objects, one or more placement poses of the one or more manipulable objects, one or more placement surfaces, one or more buttons, or one or more poses at which the one or more buttons can be pressed.
13. The one or more non-transitory computer-readable media of clauses 11 or 12, wherein the symbolic elements comprise at least one of a first predicate for the robot being at a configuration, a second predicate for a gripper of the robot being empty, a third predicate for an object being at a pose, a fourth predicate for the object being at a grasped pose, a fifth predicate for the object being placed on a surface, a sixth predicate for the object being a stick that can be used to press one or more buttons, or a seventh predicate for confirming that the one or more buttons are pressed.
14. The one or more non-transitory computer-readable media of any of clauses 11-13, wherein generating the TAMP-domain representation comprises generating, based on the TAMP-domain language input and the TAMP-domain language data, an AST, generating, based on the AST, one or more constraint graph templates, generating, based on the one or more constraint graph templates and the one or more subgraph classification rules, subgraph tag metadata, and generating, based on the one or more constraint graph templates and the subgraph tag metadata, the TAMP-domain representation.
15. The one or more non-transitory computer-readable media of any of clauses 11-14, wherein the one or more constraint graph templates comprises at least one of one or more first nodes representing one or more symbolic variables, one or more second nodes representing one or more continuous variables, one or more third nodes representing one or more constraints, one or more cost nodes representing one or more cost functions defined over the one or more continuous variables, or one or more edges to capture one or more dependencies based on the one or more constraints and at least one of the one or more symbolic variables or the one or more continuous variables, wherein each edge included in the one or more edges connects at least one of a symbolic variable included in the one more symbolic variables or a continuous variable included in the one or more continuous variables to at least one of a constraint node included in the one or more third nodes or a cost node included in the one or more cost nodes.
16. The one or more non-transitory computer-readable media of any of clauses 11-15, wherein generating the subgraph tag metadata comprises identifying one or more groups of one or more related constraints and one or more related variables.
17. The one or more non-transitory computer-readable media of any of clauses 11-16, wherein generating the subgraph tag metadata comprises prioritizing at least one of one or more larger subgraphs included in the one or more constraint graph templates or one or more commonly sampled subgraphs included in the one or more constraint graph templates.
18. The one or more non-transitory computer-readable media of any of clauses 11-17, wherein generating the TAMP-domain representation comprises serializing one or more constraint graph templates and subgraph tag metadata into a machine-readable format.
19. The one or more non-transitory computer-readable media of any of clauses 11-18, wherein the instructions, when executed by the one or more processors, further cause the one or more processors to perform the steps of generating the state based on sensor data.
20. In some embodiments, a system comprises one or more memories storing instructions, and one or more processors that are coupled to the one or more memories and, when executing the instructions, are configured to receive a TAMP-domain language input comprising one or more symbolic elements and one or more continuous elements, generate a TAMP-domain representation based on the TAMP-domain language input, TAMP-domain language data, and one or more subgraph classification rules, generate a robot plan based on the TAMP-domain representation, a state, and a goal, and cause a robot to perform at least part of the robot plan.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for controlling a robot, the method comprising:
receiving a task and motion planning (TAMP)-domain language input comprising one or more symbolic elements and one or more continuous elements;
generating a TAMP-domain representation based on the TAMP-domain language input, TAMP-domain language data, and one or more subgraph classification rules;
generating a robot plan based on the TAMP-domain representation, a state, and a goal; and
causing the robot to perform at least part of the robot plan.

2. The computer-implemented method of claim 1, wherein the continuous elements comprise at least one of:
one or more robot configurations;
one or more manipulable objects;
one or more placement poses of the one or more manipulable objects;
one or more placement surfaces;
one or more buttons; or
one or more poses at which the one or more buttons can be pressed.

3. The computer-implemented method of claim 1, wherein the symbolic elements comprise at least one of:
a first predicate for the robot being at a configuration;
a second predicate for a gripper of the robot being empty;
a third predicate for an object being at a pose;
a fourth predicate for the object being at a grasped pose;
a fifth predicate for the object being placed on a surface;
a sixth predicate for the object being a stick that can be used to press one or more buttons; or
a seventh predicate for confirming that the one or more buttons are pressed.

4. The computer-implemented method of claim 1, wherein the TAMP-domain language data comprises at least one of one or more types, one or more predicates, one or more constraints, or one or more action schemas.

5. The computer-implemented method of claim 4, wherein the one or more constraints comprise at least one of:
a constraint to connect a trajectory between a first configuration and a second configuration;
a constraint for a robot configuration to satisfy inverse kinematics with respect to an object grasped at a first pose and placed at a second pose;
a constraint to satisfy a valid grasp pose for an object;
a constraint for stable placement of an object on a surface;
one or more constraints for a collision-free trajectory; or
a constraint for valid pressing motion onto a button.

6. The computer-implemented method of claim 4, wherein the one or more action schemas comprise at least one of:
a first action schema to move the robot freely from a first configuration to a second configuration along a trajectory;
a second action schema to pick an object at a placement pose with a grasp and a third configuration;
a third action schema to move the robot from the first configuration to the second configuration while holding the object with the grasp;
a fourth action schema to place the object held at the grasp on a surface at the placement pose using the third configuration;
a fifth action schema to press a button using a pose and a fourth configuration; or
a sixth action schema to press the button using a stick object held at the grasp and the pose and a fifth configuration.

7. The computer-implemented method of claim 1, wherein generating the TAMP-domain representation comprises:
generating, based on the TAMP-domain language input and the TAMP-domain language data, an abstract syntax tree (AST);
generating, based on the AST, one or more constraint graph templates;
generating, based on the one or more constraint graph templates and the one or more subgraph classification rules, subgraph tag metadata; and
generating, based on the one or more constraint graph templates and the subgraph tag metadata, the TAMP-domain representation.

8. The computer-implemented method of claim 7, wherein the one or more constraint graph templates comprises at least one of:
one or more first nodes representing one or more symbolic variables;
one or more second nodes representing one or more continuous variables;
one or more third nodes representing one or more constraints;
one or more cost nodes representing one or more cost functions defined over the one or more continuous variables; or
one or more edges to capture one or more dependencies based on the one or more constraints and at least one of the one or more symbolic variables or the one or more continuous variables, wherein each edge included in the one or more edges connects at least one of a symbolic variable included in the one more symbolic variables or a continuous variable included in the one or more continuous variables to at least one of a constraint node included in the one or more third nodes or a cost node included in the one or more cost nodes.

9. The computer-implemented method of claim 7, wherein generating the subgraph tag metadata comprises identifying one or more groups of one or more related constraints and one or more related variables.

10. The computer-implemented method of claim 7, wherein generating the subgraph tag metadata comprises prioritizing at least one of one or more larger subgraphs included in the one or more constraint graph templates or one or more commonly sampled subgraphs included in the one or more constraint graph templates.

11. One or more non-transitory computer-readable media storing instructions that, when executed by one or more processors, cause the one or more processors to perform the steps of:
receiving a TAMP-domain language input comprising one or more symbolic elements and one or more continuous elements;
generating a TAMP-domain representation based on the TAMP-domain language input, TAMP-domain language data, and one or more subgraph classification rules;
generating a robot plan based on the TAMP-domain representation, a state, and a goal; and
causing a robot to perform at least part of the robot plan.

12. The one or more non-transitory computer-readable media of claim 11, wherein the continuous elements comprise at least one of:
one or more robot configurations;
one or more manipulable objects;
one or more placement poses of the one or more manipulable objects;
one or more placement surfaces;
one or more buttons; or
one or more poses at which the one or more buttons can be pressed.

13. The one or more non-transitory computer-readable media of claim 11, wherein the symbolic elements comprise at least one of:
a first predicate for the robot being at a configuration;
a second predicate for a gripper of the robot being empty;
a third predicate for an object being at a pose;
a fourth predicate for the object being at a grasped pose;
a fifth predicate for the object being placed on a surface;
a sixth predicate for the object being a stick that can be used to press one or more buttons; or
a seventh predicate for confirming that the one or more buttons are pressed.

14. The one or more non-transitory computer-readable media of claim 11, wherein generating the TAMP-domain representation comprises:
generating, based on the TAMP-domain language input and the TAMP-domain language data, an AST;
generating, based on the AST, one or more constraint graph templates;
generating, based on the one or more constraint graph templates and the one or more subgraph classification rules, subgraph tag metadata; and
generating, based on the one or more constraint graph templates and the subgraph tag metadata, the TAMP-domain representation.

15. The one or more non-transitory computer-readable media of claim 14, wherein the one or more constraint graph templates comprises at least one of:
one or more first nodes representing one or more symbolic variables;
one or more second nodes representing one or more continuous variables;
one or more third nodes representing one or more constraints;
one or more cost nodes representing one or more cost functions defined over the one or more continuous variables; or
one or more edges to capture one or more dependencies based on the one or more constraints and at least one of the one or more symbolic variables or the one or more continuous variables, wherein each edge included in the one or more edges connects at least one of a symbolic variable included in the one more symbolic variables or a continuous variable included in the one or more continuous variables to at least one of a constraint node included in the one or more third nodes or a cost node included in the one or more cost nodes.

16. The one or more non-transitory computer-readable media of claim 14, wherein generating the subgraph tag metadata comprises identifying one or more groups of one or more related constraints and one or more related variables.

17. The one or more non-transitory computer-readable media of claim 14, wherein generating the subgraph tag metadata comprises prioritizing at least one of one or more larger subgraphs included in the one or more constraint graph templates or one or more commonly sampled subgraphs included in the one or more constraint graph templates.

18. The one or more non-transitory computer-readable media of claim 11, wherein generating the TAMP-domain representation comprises serializing one or more constraint graph templates and subgraph tag metadata into a machine-readable format.

19. The one or more non-transitory computer-readable media of claim 11, wherein the instructions, when executed by the one or more processors, further cause the one or more processors to perform the steps of generating the state based on sensor data.

20. A system comprising:
one or more memories storing instructions, and
one or more processors that are coupled to the one or more memories and, when executing the instructions, are configured to:
receive a TAMP-domain language input comprising one or more symbolic elements and one or more continuous elements,
generate a TAMP-domain representation based on the TAMP-domain language input, TAMP-domain language data, and one or more subgraph classification rules,
generate a robot plan based on the TAMP-domain representation, a state, and a goal, and
cause a robot to perform at least part of the robot plan.
